(19) United States
(12) Patent Application Publication
(10) Pub. No.: US 2023/0236031 A1
(43) Pub. Date: Jul. 27, 2023

(54) INFORMATION PROVIDING APPARATUS AND INFORMATION PROVIDING METHOD USING AN INFORMATION TERMINAL

(71) Applicant: DOT INCORPORATION, Seoul (KR)

(72) Inventors: Ji Ho Kim, Incheon (KR); Ju Yoon Kim, Gwangmyeong-si (KR); Hyun Chul Park, Gwangmyeong-si (KR)

(73) Assignee: DOT INCORPORATION, Seoul (KR)

(21) Appl. No.: 17/981,069

(22) Filed: Nov. 4, 2022

Related U.S. Application Data
(63) Continuation of application No. 17/997,809, filed on Jan. 1, 0001.

(30) Foreign Application Priority Data
Dec. 31, 2020 (KR) 10-2020-0189261
Dec. 31, 2020 (KR) 10-2020-0189278
Dec. 31, 2020 (KR) 10-2020-0189292

(51) Int. Cl. G01C 21/34; G01C 21/36

(52) U.S. Cl. CPC G01C 21/3484; G01C 21/3605

(57) ABSTRACT

An apparatus and method for providing a layer-based service with improved information accessibility are disclosed, and the method for providing a layer-based service with improved information accessibility according to an embodiment of the present application includes the operations of obtaining manipulation information and interface information for a target service, building an accessible layer corresponding to the target service by improving information accessibility associated with a user interface and a user experience of the target service based on the manipulation information and the interface information, and providing the target service based on the accessible layer.

### CROSS REFERENCE TO RELATED APPLICATIONS

This application is a continuation of U.S. application Ser. No. 17/997,809 filed on Nov. 2, 2022, which is a National Stage of International Application No. PCT/KR2021/019151 filed Dec. 16, 2021, claiming priority based on Korean Patent Application No. 10-2020-0189261 filed Dec. 31, 2020; Korean Patent Application No. 10-2020-0189278 filed Dec. 31, 2020; and Korean Patent Application No. 10-2020-0189292 filed Dec. 31, 2020.

### TECHNICAL FIELD

The present application relates to an apparatus and method for providing a layer-based service with improved information accessibility, an information terminal supporting an access guide providing and a customized preset and a method of providing information using the same, and an information providing apparatus in which a user terminal is linked with an information terminal and a method of providing information using the same.

### BACKGROUND ART

With the recent 4th industrial revolution and the development of IT technology, a variety of information can be obtained by accessing the Internet anytime and anywhere through smart devices such as smart phones and tablet PCs. In addition, in recent years, the percentage of disabled users who have computers and smartphones and use the Internet tends to gradually increase, and thus, those disabled users, like non-disabled users, use personal computers and smart phones to access online services, such as an e-government, an internet banking, an e-commerce, an online education, and online news. For those reasons, information devices such as smart phones are becoming essential tools and one of the most important means of living for disabled people.

However, since most of the services accessible by using the above-mentioned information apparatuses are mainly developed and released for non-disabled users, it is difficult for the disabled to utilize the conventional services developed with the focus only on the usability of non-disabled users. It requires a lot of effort, and depending on the user, it may not be possible to fully utilize the service.

In particular, the concept of Web Accessibility, which guarantees that the information provided by the website can be accessed and used on an equal basis with non-disabled users for users such as the disabled and the elderly, takes into account the sight and hearing, the mobility, and the cognitive ability of the information vulnerable class users. Although partially applied as a legal requirement, the Web Accessibility is not sufficiently guaranteed for the information vulnerable class users in such several applications (App) that are mainly installed and executed on smart phones.

On the other hand, some exclusive applications (Apps) for the disabled users or information devices having some functions for the disabled users have been released, but there are inconveniences in that the disabled users have to be newly acquainted with well how to use the applications or the information devices. In addition, most of the exclusive applications and the information devices for the disabled users cannot be linked with the applications for non-disabled users. Thus, the exclusive applications and the information devices for the disabled users are not practically helpful to the disabled users, and accordingly, the use rate of disabled users is not sufficiently secured.

Therefore, there is a need for a method that can simultaneously guarantee the usability of disabled and non-disabled users for the same service by improving conventional services, which are oriented to the usability of non-disabled users, and by providing the improved services in consideration of the information accessibility of the disabled users.

In addition, due to the recent 4th industrial revolution and the development of IT technology, unmanned devices (e.g. kiosks, etc.), which replaces the conventional workers in providing various information and services, have appeared in large numbers, and the frequency of their use is increasing worldwide. However, since most of the current unmanned devices mainly are produced, disseminated, and operated towards a target of non-disabled users and users of younger age groups, it is hardly difficult for the information vulnerable users, such as disabled users and elderly users, to access and use the services provided by the current unmanned devices.

In this regard, the number of disabled people accounts for about 15% of the world's population, reaching 1 billion people worldwide. In addition, the aging population has been intensified from countries of G20, and thus, it is expected that the aged population ratio reaches about 17% of the world's population by the year of 2050. After all, in the future, the disabled or the elderly may increase to about 3 out of 10 of the total population. In addition, considering that the adoption of unmanned devices is an inevitable trend that no one can resist due to the lack of service workers, it is expected that information inequality in information vulnerable users, such as the disabled users and the elderly users, continues to intensify and becomes a big social issue.

Meanwhile, in Korea, reflecting those trends, revised bills of the Framework Act on National Informatization and the Discrimination Disability Act have been recently approved. The main contents of the revised bills are that disabled users are allowed to access and use services on an equal basis with non-disabled users. Thus, it is evaluated that the discrimination against the disabled users be abolished in the use of unmanned terminals.

However, as the automation level of unmanned devices gradually increases and the range of services that can be replaced by the unmanned devices expands, the unmanned devices tend to be actively introduced in stores and public places. In contrast to the above tendency, it is still hardly difficult for the information vulnerable users to access to the unmanned devices, and the unmanned devices still continue to be a barrier to the aforementioned information vulnerable users as the unmanned devices are operated on the premise that the users are well-acquainted with the usage of the unmanned device.

Therefore, there has been a need for an improved unmanned devices responsive or customized to factors related to the user interface and user experience in consideration of the usage environment of the unmanned devices and the user characteristics, so that most users, including the information vulnerable users, can use the unmanned devices without difficulty.

Recently, the percentage of disabled users who have computers and smartphones and use the Internet tends to gradually increase, and thus, those disabled users, like non-disabled users, use personal computers and smart phones to access online services, such as an e-government, an internet banking, an e-commerce, an online education, and online news. For those reasons, information devices such as smart phones are becoming essential tools and one of the most important means of living for the disabled people.

Therefore, the need for a method of utilizing the unmanned devices through interlinking with the user's terminal continues to rise up recently. Thus, the unmanned device accessed by user is required for providing necessary customized information in relation to the information stored in the disabled user's terminal. In addition, the user's terminal is required for receiving necessary information by a remote control to the unmanned device through interlinking (pairing) with the user's terminal.

Background arts of the present application are disclosed in Korean Patent Application Laid-Open No. 10-2017-0124201.

### DESCRIPTION OF DISCLOSURE

### Technical Problem

The present application is intended to solve the problems of the prior art described above, and an object of the present disclosure is to provide an apparatus and method for providing a layer-based service with improved information accessibility in which the conventional services, such as programs and applications, for non-disabled users are provided to information vulnerable users, such as the elderly and the disabled, with improved usability of a user, so that the conventional services are utilized across various users.

The present application is intended to solve the problems of the prior art described above, and an object of the present disclosure is to provide an information terminal supporting an access guide providing and a customized preset and a method of providing information using the same in which an access guide is provided by matching an information terminal to which a user, who approaches to a target space in which the information terminal is installed, is easily accessible, and preset customized settings are performed to UI/UX of the matched information terminal in consideration of user information of the user approaching the target space, to thereby support the access guide providing and the preset customized settings for assisting users having difficulties in utilizing the information terminal, such as a disabled user, to use the information terminal conveniently.

The present application is intended to solve the problems of the prior art described above, and an object of the present disclosure is to provide an information providing apparatus including a user terminal and an information terminal interlinked with each other and a method of providing information using the same in which information provided to a user from an information terminal of an unmanned device, etc. is transmitted to a user terminal associated with the information terminal for utilizing the information after the user terminates the usage of the unmanned device.

The present application is intended to solve the problems of the prior art described above, and an object of the present disclosure is to provide an information providing apparatus including a user terminal and an information terminal interlinked with each other and a method of providing information using the same in which information provided from an information terminal of an unmanned device, etc. is remotely provided to a user by a user terminal associated with the information terminal in an adjacent area spaced apart from the information terminal.

The present application is intended to solve the problems of the prior art described above, and an object of the present disclosure is to provide an information providing apparatus including a user terminal and an information terminal interlinked with each other and a method of providing information using the same in which a plurality of users simultaneously uses a single information terminal such as an unmanned device by interlinking each of the plurality of users with the information terminal.

However, the technical problems to be achieved by embodiments of the present application are not limited to the technical problems as described above, and other technical problems may exist.

### Solution to Problem

As a technical means for achieving the above technical problems, a method of providing a layer-based service with improved information accessibility according to an embodiment of the present application may include an operation of obtaining manipulation information and interface information for a target service, an operation of building an accessible layer corresponding to the target service by improving the information accessibility associated with a user interface and a user experience of the target service based on the manipulation information and the interface information, and an operation of providing the target service based on the accessible layer.

In addition, the manipulation information may include information on a control input application method associated with the target service.

In addition, the interface information may include information on an information output method associated with the target service.

In addition, the operation of the building the accessible layer may include an operation of building a first accessible layer for a visually impaired user in which the first accessible layer may be controlled based on at least one of a touch input method and a voice input method and predefined information may be displayed based on at least one information output method of a voice output method and a braille output method.

In addition, the operation of the building the accessible layer may include an operation of building a second accessible layer for a hearing-impaired user in which the second accessible layer is controlled based on at least one control input application method of a touch input method and a gesture output method, and information is displayed based on at least one information output method of an intuitive visual information output method and a gesture output method.

In addition, the operation of the providing the target service may include an operation of obtaining disability type information of a user who is provided with the target service and an operation of providing the target service based on the accessible layer built correspondently to the disability type information.

In addition, the target service may include a route guidance service for providing route information from a departure point to a destination.

In addition, the operation of the building of the accessible layer may include an operation of building the accessible layer for generating the route information based on the disability type information of the user receiving the route guidance service.

In addition, the route guidance service may provide surrounding information about a predefined location.

In addition, the operation of the building of the accessible layer may include an operation of building the accessible layer for generating the surrounding information based on the disability type information of the user receiving the route guidance service.

In addition, the surrounding information may include at least one of low-rise main information for each building in an adjacent area of the predefined location, information on convenient facilities, first obstacle information on a movement impeding factor obtained in advance, and second obstacle information on a flexibly grasped movement impeding factor for the adjacent area.

In addition, the operation of the providing the target service may include an operation of obtaining location information of a user who is provided with the target service and an operation of providing warning alarms based on a gap distance between the location information and the obstacle information including the first obstacle information and the second obstacle information.

On the other hand, a layer-based service providing apparatus with improved information accessibility according to an embodiment of the present application includes an information collector configured to obtain manipulation information and interface information for a target service, a layer builder configured to build an accessible layer corresponding to the target service by improving the information accessibility linked to the user interface and the user experience of the target service based on the manipulation information and the interface information, and a service provider configured to provide the target service based on the accessible layer.

In addition, the layer builder may be configured to build a first accessible layer for a visually impaired user in which the first accessible layer may be controlled based on at least one control input application method of a touch input method and a voice input method and predefined information may be displayed based on at least one information output method of a voice output method and a braille output method, and to build a second accessible layer for a hearing-impaired user in which the second accessible layer may be controlled based on at least one control input application method of a touch input method and a gesture input method, and some information may be displayed based on at least one information output method of an intuitive visual information output method and a gesture output method.

In addition, the service provider may be configured to obtain a disability type information of a user who is provided with the target service and to provide the target service based on the accessible layer built correspondently to the disability type information.

In addition, the layer builder may be configured to build the accessible layer for generating at least one of the route information and the surrounding information based on disability type information of a user who is provided with the route guidance service.

As a technical means for achieving the above technical problem, an information providing method using an information terminal that may support the access guide providing and a customized preset according to an embodiment of the present application may include an operation of obtaining location information of a user terminal owned by a user, an operation of matching the information terminal based on the location information, an operation of providing access guide information for the matched information terminal to the user terminal, and an operation of changing elements related to a user interface and a user experience of the matched information terminal to customized settings for the user based on the user information of the user.

In addition, the operation of changing to the customized setting may include changing a control input application method and an information output method which are associated with the matched information terminal based on the user's disability information into the customized settings for the user.

In addition, the operation of matching the information terminal may be performed in consideration of at least one of walking ability of the user, route information from the location information to a predefined destination, and a gap distance from the location information to the information terminal.

In addition, the operation of providing the access guide information may include an operation of generating access guide information for guiding a path from the location information to the location of the matched information terminal in consideration of at least one of the user's disability information and the walking ability, and an operation of transmitting the matching result and the access guide information to the user terminal.

In addition, the user information may include may include at least one of first user information, which is user information obtained in advance from the user terminal or pre-constructed database and second user information, which is user information derived from at least one of appearance characteristics, behavior characteristics, and object characteristics of a user that may be identified in the process for the user to have access to the matched information terminal.

In addition, when the disability information is a visually impaired user, the operation of changing to the customized setting is performed in such a way that the matched information terminal is controlled based on at least one control input application method of a braille input method, a voice input method, and an intuitive touch input method, and predefined information is displayed based on at least one information output method of a voice output method and a braille output method.

In addition, when the disability information is a hearing-impaired user, the operation of changing to the customized setting may be performed in such a way that the matched information terminal is controlled based on at least one control input application method of a touch input method and a gesture input method, and information is displayed based on at least one information output method 5 of an intuitive visual information output method and a gesture output method.

In addition, when the disability information is a physically disabled user, the operation of changing to the customized setting may be performed in such a way that the matched information terminal is controlled based on at least one control input application method of a touch input, a physical key input, and a gesture input, using the lower interface of the display of the matched information terminal.

In addition, the information providing method using an information terminal that supports an access guide providing and a customized preset according to an embodiment of the present application may include an operation of receiving a search input applied to the matched information terminal based on the customized settings after the user approaches to the matched information terminal and an operation of providing predefined information corresponding to the search input through the matched information terminal based on the customized settings.

On the other hand, the information providing apparatus using an information terminal that supports the access guide providing and customized preset according to an embodiment of the present application may include an information terminal matching unit configured to obtain location information of a user terminal owned by a user and to match the information terminal based on the obtained location information of the user, an access guide providing unit configured to provide access guide information on the matched information terminal to the user terminal, and a presetting unit configured to change elements associated with a user interface and a user experience of the matched information terminal into customized settings for the user based on the user information of the user.

In addition, the presetting unit may change a control input application method and an information output method associated with the matched information terminal in customized settings based on the disability information of the user.

In addition, the information terminal matching unit may perform the matching in consideration of at least one of walking ability of the user, route information from the location information to a predefined destination, and a gap distance from the location information to the information terminal.

In addition, the access guide providing unit may generate the access guide information for guiding a path from the location information to the location of the matched information terminal in consideration of at least one of the user's disability information and the walking ability.

In addition, the access guide providing unit may transmit the matching result and the access guide information to the user terminal.

In addition, the information providing apparatus using an information terminal that supports the provision of an access guide and a customized preset according to an embodiment of the present application may include a target information providing unit configured to receive a search input applied to the matched information terminal based on the customized setting after the user approaches the matched information terminal and to provide predefined information corresponding to the search input through the matched information terminal based on the customized settings.

On the other hand, the information terminal supporting the access guide providing and the customized preset according to an embodiment of the present application may be matched based on location information of a user terminal, and elements associated with a user interface and a user experience of the information terminal may be changed in advance into customized settings based on user information of the user before the user of the user terminal approaches to the information terminal.

In addition, the information terminal supporting the access guide providing and the customized presetting according to an embodiment of the present application may include an input receiving unit configure to receive a search input based on the customized settings and an information output unit configured to provide predefined information corresponding to the search input based on the customized settings.

As a technical means for achieving the technical problem described above, the information providing method by interlinking a user terminal with an information terminal according to an embodiment of the present application may include an operation of collecting, from an information terminal that outputs predefined information in response to a search input, guide data that is output through the information terminal, an operation of interlinking the information terminal with the user terminal owned by a user, an operation of generating target data that includes at least a portion of the collected guide data, and an operation of transmitting the generated target data to the linked user terminal.

In addition, the operation of generating the target data may determine a format of the target data based on disability information of the user.

In addition, the information providing method by interlinking the user terminal with the information terminal according to an embodiment of the present application may include an operation of obtaining prior search data related to predefined information that is provided by the information terminal from the user terminal prior to the operation of collecting the guide data.

In addition, the guide data may be determined based on a search input matching the prior search data and provided to the user by the information terminal.

In addition, when the search input includes a predefined destination and the guide data includes route information to the destination, the target data may be generated to include the route information.

In addition, when the disability information corresponds to a visually impaired user, the operation of generating the target data may determine the format of the target data as at least one of voice data and braille data.

In addition, when the disability information corresponds to a hearing-impaired user, the operation of generating the target data may determine the format of the target data as graphic data.

In addition, the graphic data may include moving image data for guiding the target data after converting the target data into the sing language.

On the other hand, the information providing method by interlinking a user terminal with an information terminal according to an embodiment of the present application may include an operation of receiving a user's search input and to thereby output guide data corresponding to the search input, an operation of interlinking the user terminal owned by the user, an operation of generating target data including at least a portion of the guide data, and an operation of transmitting the generated target data to the linked user terminal.

On the other hand, the information providing method by interlinking a user terminal with an information terminal according to another embodiment of the present application may include an operation of interlinking an information terminal that outputs predefined information in response to a search input with a user terminal owned by a user, an operation of receiving the search input, which is applied to the interlinked user terminal, from the user terminal, and an operation of transmitting the guide data provided from the information terminal in response to the received search input to the user terminal.

In addition, the operation of interlinking the user terminal and the information terminal may be performed by an interlinking process between the information terminal and the user terminal located within a preset allowable distance from the information terminal based on the wireless communication.

In addition, the interlinking process may be independently performed for each of a plurality of user terminals.

On the other hand, the information providing apparatus by using an interlink of a user terminal and an information terminal according to an embodiment of the present application may include a data collecting unit configured to collect, from an information terminal that outputs predefined information in response to a search input, guide data that is output through the information terminal, a terminal interlink unit configured to interlink the information terminal with the user terminal owned by a user, a target data generator configured to generate the target data including at least a portion of the collected guide data, and a data transmitting unit configured to transmit the generated target data to the user terminal.

In addition, the target data generator may determine a format of the target data based on the disability information of the user.

In addition, when the search input includes a predefined destination and the guide data includes route information to the destination, the target data generator may generate the target data to include the route information.

In addition, when disability information corresponds to a visually impaired user, the target data generator may determine a format of the target data as at least one of voice data and braille data.

In addition, when the disability information corresponds to a hearing-impaired user, the target data generator may determine the format of the target data as graphic data.

On the other hand, the information providing apparatus by interlinking a user terminal with an information terminal according to another embodiment of the present application may include a terminal interlink unit configured to link an information terminal for outputting predefined information in response to a search input with a user terminal owned by the user and a search performing unit configured to receive, from the user terminal, the search input applied to the interlinked user terminal and to transmit the guide data to the user terminal from the information terminal in response to the received search input.

In addition, the terminal interlink unit may perform an interlink process between the information terminal and the user terminal positioned within a preset allowable distance from the information terminal over a wireless communication of the user terminal.

In addition, the terminal interlink unit may independently perform the interlinking process on each of a plurality of user terminals.

The above-described means for solving problems are merely illustrative, and should not be construed as limiting the present application. In addition to the exemplary embodiments described above, additional embodiments may exist in the drawings and detailed description of disclosure.

### Advantageous Effects of Disclosure

According to the above-described means for solving problems of the present application, an apparatus and a method for providing a layer-based service with improved information accessibility are provided in such a manner that the conventional services, such as programs and applications, for non-disabled users are provided to information vulnerable users, such as the elderly and the disabled, with improved usability of a user, so that the conventional services are utilized across various users.

According to the above-described means for solving problems of the present application, the accessible layer for improving information accessibility of information vulnerable users is overlayed onto the conventional target services with maintaining overall contents of the conventional target service, to thereby providing services useable to both of the disabled users and the non-disabled users and to guide an active service usage for the disabled users.

According to the above-described means for solving problems of the present application, the information access opportunities may be expanded to the disabled users who have difficulties in an access to information by using information and communication technology, which increases the social participation of the information vulnerable groups to reduce a feeling of social alienation, and allows various services such as education, medical care, and transportation without discrimination due to the disability and old ages, to thereby improve the life quality of the disabled users.

According to the above-described means for solving problems of the present application, the access guide is provided by matching an information terminal to which a user, who approaches to a target space in which the information terminal is installed, is easily accessible, and the preset customized settings are performed to UI/UX of the matched information terminal in consideration of user information of the user approaching the target space, to thereby support the access guide providing and the preset customized settings for assisting users having difficulties in utilizing the information terminal, such as a disabled user, to use the information terminal conveniently.

According to the above-described means for solving problems of the present application, even when the user does not accurately recognize the location of the information terminal in the target space, the user can easily reach the information terminal and receive necessary information conveniently by using the access guide information.

According to the above-described means for solving problems of the present application, the usability of the information terminal is preset in customized settings in consideration of the user information, such as the user's disability type, age, audio/visual ability, physical ability, etc., so that the information vulnerable users may easily use the information terminal.

According to the above-described means for solving problems of the present application, the information access opportunities can be expanded to the disabled users who have difficulties in an access to information by using information and communication technology, which increases the social participation of the information vulnerable groups to reduce a feeling of social alienation, and allows various services such as education, medical care, and transportation without discrimination due to the disability and old ages, to thereby improve the life quality of the disabled users.

According to the above-described means for solving problems of the present application, the information providing apparatus including a user terminal and an information terminal interlinked with each other and the method of providing information using the same are disclosed in such a manner that the information provided to the user from the information terminal of an unmanned device, etc. is transmitted to the user terminal associated with the information terminal for utilizing the information after the user terminates the usage of the unmanned device.

According to the above-described means for solving problems of the present application, the information providing apparatus including a user terminal and an information terminal interlinked with each other and the method of providing information using the same are disclosed in such a manner that the information provided from the information terminal of an unmanned device, etc. is remotely provided to a user by the user terminal associated with the information terminal in an adjacent area spaced apart from the information terminal.

According to the above-described means for solving problems of the present application, the information providing apparatus including a user terminal and an information terminal interlinked with each other and the method of providing information using the same are disclosed in such a manner that a plurality of the users simultaneously uses a single information terminal, such as an unmanned device, by interlinking each of the plurality of users with the information terminal.

According to the above-described means for solving problems of the present application, the information access opportunities can be expanded to the disabled users who have difficulties in an access to information by using information and communication technology, which increases the social participation of the information vulnerable groups to reduce a feeling of social alienation, and allows various services such as education, medical care, and transportation without discrimination due to the disability and old ages, to thereby improve the life quality of the disabled users.

However, the effects obtainable from the present application are not limited to the above-described effects, and other effects may exist.

### BRIEF DESCRIPTION OF DRAWINGS

FIG. 1 is a schematic structural view illustrating a service providing system including a layer-based service providing apparatus with improved information accessibility, according to an embodiment of the present application.

FIG. 2 is a schematic configuration view of a service providing system for providing a target service by using information obtained from a plurality of user terminals and a plurality of fixed information terminals.

FIG. 3 is a view exemplarily illustrating a target service providing interface on a user terminal based on an accessible layer.

FIG. 4 is a schematic configuration view of a service providing apparatus for a layer-based service with improved information accessibility according to an embodiment of the present application.

FIG. 5 is an operation flowchart showing a method of providing a layer-based service with improved information accessibility according to an embodiment of the present application.

FIG. 6 is a detailed operation flowchart showing a method of providing a layer-based service with improved information accessibility in which a route guidance service is provided as the target service.

FIG. 7 is a schematic configuration view of an information providing system including an information providing apparatus that uses an information terminal for supporting an access guide providing and a customized preset according to an embodiment of the present application.

FIG. 8 is a view exemplarily illustrating a shape of the information terminal according to an embodiment of the present application.

FIG. 9 is a view exemplarily illustrating a detailed structure of the main controller of the information terminal according to an embodiment of the present application.

FIG. 10 is a conceptual view illustrating an input by using a lower interface as a customized setting for a physical disabled user.

FIG. 11 is a view illustrating an interface displayed on an information terminal matching a predefined user prior to an access of the predefined user to the matched information terminal.

FIG. 12 is a schematic configuration view of an information providing apparatus using an information terminal which supports an access guide providing and a customized preset according to an embodiment of the present application.

FIG. 13 is an operation flowchart of a method of providing information by using an information terminal that supports the access guide providing and the customized preset according to an embodiment of the present application.

FIG. 14 is a schematic configuration view of an information providing system including an information providing apparatus in which a user terminal and an information terminal are interlinked with each other, according to an embodiment of the present application.

FIG. 15 is a view exemplarily showing the configuration of an information terminal, according to an embodiment of the present application.

FIG. 16 is a view exemplarily illustrating a detailed structure of the main controller of the information terminal according to an embodiment of the present application.

FIG. 17 is a schematic configuration view of an information providing system including an information providing apparatus in which a user terminal and an information terminal are interlinked with each other, according to another embodiment of the present application.

FIG. 18 is a schematic configuration view of an information providing apparatus in which a user terminal and an information terminal are interlinked with each other, according to an embodiment of the present application.

FIG. 19 is a schematic configuration view of an information providing apparatus in which a user terminal and an information terminal are interlinked with each other, according to another embodiment of the present application.

FIG. 20 is an operation flowchart showing a method of providing information by interlinking a user terminal with an information terminal, according to an embodiment of the present application.

FIG. 21 is an operation flowchart showing a method of providing information by interlinking a user terminal with an information terminal, according to another embodiment of the present application.

### SPECIFIC CONTENT FOR IMPLEMENTING THE DISCLOSURE

Hereinafter, embodiments of the present application will be described in detail with references to the accompanying drawings in such a manner that those of ordinary skill in the art to which the present application pertains can easily implement them. However, the present application may be implemented in several different forms and is not limited to the embodiments described herein. And in order to clearly explain the present application in the drawings, portions irrelevant to the descriptions are omitted, and similar reference numerals are attached to similar portions throughout the specification.

Throughout this specification, when a part is “connected” with another part, it is not only “directly connected” but also “electrically connected”, or “indirectly connected” with another element interposed therebetween.

Throughout this specification, when it is said that a member is positioned “on”, “on an upper portion of”, “on a top of”, “under”, “on a lower portion of”, and “on a bottom of” another member, this means that a member is located on the other member. It includes not only the case where they are in contact, but also the case where another member exists between two members.

Throughout this specification, when a portion or a part “includes” a component or an element, it means that other components or elements may be further included, rather than excluding other components, unless otherwise stated.

The present application relates to an apparatus and method for providing a layer-based service with improved information accessibility.

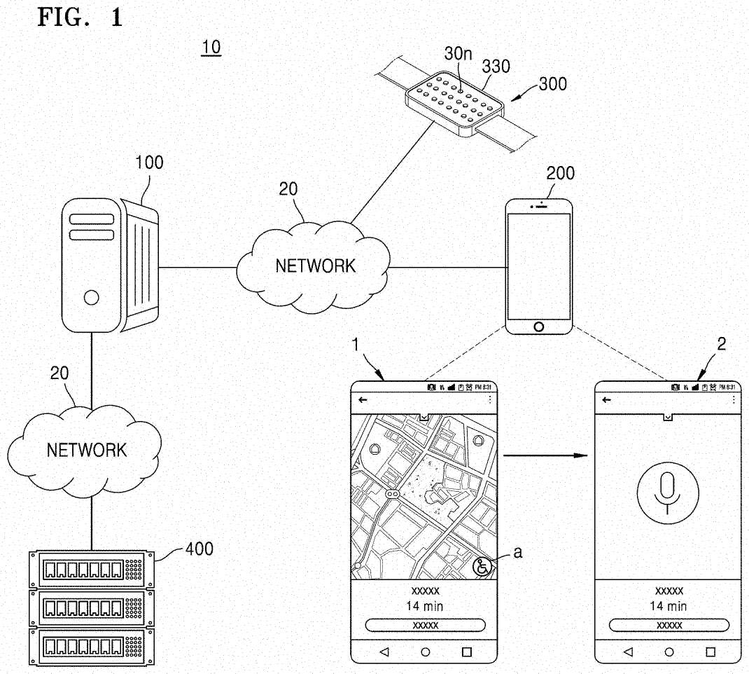

FIG. 1 is a schematic structural view illustrating a service providing system including a layer-based service providing apparatus with improved information accessibility, according to an embodiment of the present application.

Referring to FIG. 1, a service providing system 10 according to an embodiment of the present application may include a layer-based service providing apparatus 100 of which the information accessibility is improved (hereinafter referred to as a ‘service providing apparatus’), a user terminal 200, an auxiliary terminal 300, and a database 400.

The service providing apparatus 100, the user terminal 200, the auxiliary terminal 300, and the database 400 may communicate with one another via a network 20. The network 20 may include a connection structure in which information is exchanged between each of nodes, such as terminals and servers. Examples of the network 20 include a 3^{rd} Generation Partnership Project (3GPP) network, a long-term evolution (LTE) network, 5th generation (5G) network, WIMAX (World Interoperability for Microwave Access) network, internet, Local Area Network (LAN), Wireless LAN (Wireless Local Area Network), WAN (Wide Area Network), PAN (Personal Area) Network), a wifi network, a Bluetooth network, a satellite broadcasting network, an analog broadcasting network, a Digital Multimedia Broadcasting (DMB) network, etc. However, the network 20 is not limited to those described above.

The user terminal 200 may include any type of wireless communication device, for example, a smartphone, a smart pad, a tablet PC and the like, and terminals for PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet).

The auxiliary terminal 300 may include, for example, a braille device capable of outputting Braille-based information for a visually impaired user (e.g., a blind person, etc.). For example, as shown in FIG. 1, the braille device may include a braille watch, a braille pad, and the like having a display on which a plurality of braille protrusion members 30n are arranged. However, the auxiliary terminal 300 is not limited to the braille device, and may further include a wide variety of devices as long as the device can be used to assist users corresponding to the information vulnerable users, such as the disabled and the elderly. For example, the auxiliary terminal 300 may include all kinds of various devices for assisting user's vision, mobility, hearing, cognitive ability, etc., such as a hearing aid, an interpreter, a walking stick, and an electric wheelchair.

In addition, according to an embodiment of the present application, the user may usually have only the user terminal 200 without a separate auxiliary terminal 300, and thus, the service providing apparatus 100 may provide a target service based on an accessible layer, which is described in detail hereinafter, through the user terminal 200. In another embodiment, the user may have the user terminal 200 and the auxiliary terminal 300 together, and thus, the service providing apparatus 100 may provide a service in such a manner that a target service based on an accessible layer may be provided through the user terminal 200 or the auxiliary terminal 300 or in such a manner that the target service based on the accessible layer may be provided mainly through the user terminal 200, and some functions interlinked with the target service may be provided adjunctively through the auxiliary terminal 300.

In addition, referring to FIG. 1, the service providing apparatus 100 disclosed herein may provide the target service to users based on the accessible layer by which the information accessibility is improved in relation with a user interface and user experiences of the conventional target service. In an example embodiment, referring to FIG. 1, the service providing apparatus 100 may make the target service outputted through the user terminal 200 in which the basic interface 1 on which the target service is executed is converted to an overlay interface 2 to which the accessible layer is overlaid.

In addition, referring to FIG. 1, the service providing apparatus 100 may change a service providing process of executing the target service in such a manner that the built-in accessible layer provided in advance is overlaid onto the target service based on an execution input applied to the accessible layer during the execution of the target service. In an example embodiment, referring to FIG. 1, the accessible layer may be overlaid onto the target service based on an accessible layer execution input (for example, a user input touching an area ‘a’ in FIG. 1) that is applied during the execution of the target service.

In the same way, the service providing apparatus 100 may also convert the overlay interface 2 to which the accessible layer is overlaid to the basic interface 1 by overlaying the accessible layer to the target service based on an accessible layer termination input or a basic interface switching input that is applied during the execution of the target service.

In summary, the service providing apparatus 100 may selectively determine whether to execute the accessible layer or whether to overlay the accessible layer based on a user input (for example, the execution input to the accessible layer, the termination input, the switching input, etc.) applied to the user terminal 200.

Hereinafter, specific functions and operations of the service providing apparatus 100 are described in detail.

The service providing apparatus 100 may obtain manipulation information and interface information for the target service. Particularly, the service providing apparatus 100 may receive information related with a target service in a state that usability of users corresponding to the information vulnerable users, such as the disabled and the elderly, is not considered. In an example embodiment, the information on the target service, such as the manipulation information, the interface information, etc., may be obtained in the form of a program code, source code, etc. that are obtained from an execution file for driving the target service.

According to an embodiment of the present application, the manipulation information for the target service may include information on a control input application method associated with the target service. Particularly, the manipulation information may include a kind of information related to an application method for the control input applied to the user terminal 200 for execution and usage of the target service, and may include information on the allowable category of the control input (for example, touch input, voice input, text input, etc.) associated with the target service.

In addition, the manipulation information for the target service may include stratified menu tree information for the execution and operation of the target service. In an example embodiment, the menu tree information may include hierarchical information on a plurality of menus, execution order information related to entry and movement between the plurality of menus, and the like, which are provided with the target service.

In addition, according to an embodiment of the present application, the interface information for the target service may include a kind of information on an information output method associated with the target service. Particularly, the interface information may include a kind of information on the allowable category of an output information (for example, a visual output method by a display, an auditory output method, a tactile output method, etc.) provided when the target service is executed correspondently to an information output component built in the user terminal 200.

In other words, the interface information herein may be understood more broadly to refer to various methods of transmitting information related to the target service to users, as well as a graphical user interface (GUI) for visually displaying the target service on the display screen of the user terminal 200. Thus, the interface information may not be referred to only as the GUI.

In addition, the service providing apparatus 100 may build an accessible layer corresponding to the target service by improving the information accessibility associated with the user interface and the user experience of the target service based on the received manipulation information and interface information on the target service.

In the description of the embodiments of the present application, “improving” the information accessibility associated with the user interface and the user experience of the target service may include providing a user-customized user interface and a user-customized user experience by changing established information input/output methods of the target service in which the usability for the information vulnerable users, such as the disabled, etc., is not considered in such a manner that information related to the target service is provided (delivered) to the information vulnerable users as being conveniently operated and easy to understand in consideration of the users' ability to access information, such as vision, mobility, hearing, cognitive ability, etc., based on the on the users' type of disability.

That is, in the present application, the accessible layer may include conversion rules for at least partially changing elements of the established user interface and the user experience of the target service in such a manner that the information vulnerable users operate conveniently and understand easily the same substances (contents) as the conventional target service. In addition, in the description of the embodiment of the present application, providing the target service in the form to which the conversion rules are applied is expressed as “overlaying” the accessible layer for better understanding.

In addition, according to an embodiment of the present application, the service providing apparatus 100 may include a first accessible layer for a visually impaired user and a second accessible layer for a hearing-impaired user.

Particularly, the service providing apparatus 100 may build the first accessible layer for the visually impaired user in such a configuration that the first accessible layer is controlled based on at least one of a touch input method and a voice input method and predefined information is displayed based on at least one information output method of a voice output method and a braille output method.

With respect to the touch input method of the first accessible layer, the service providing apparatus 100 may receive control inputs related to an entry (selection) to menu and a movement between menus of the target service, by a touch display of the user terminal 200 or the auxiliary terminal 300 based on the menu tree information, which is included in the manipulation information of the target service, in such a manner that the control inputs of the users are received by using an entire area of the touch display, rather than being received based on buttons and icons that are locally provided on the touch display.

In an example embodiment, the service providing apparatus 100 may build the first accessible layer to include functions that enable manipulations, such as the entry (selection) to a menu, the movement between menus, etc., provided with the target service, by a simplified touch control method, which is performed with sufficient ease by the visually impaired user. The simplified touch control method may include a control input for touching at least a portion of an inner area of the touch display once or more, a control input for dragging (sliding) at least a portion of an inner area of the touch display, etc.

In addition, in this regard, the service providing apparatus 100 may set up various manipulation methods of the target service in customized settings based on the menu tree information in the manipulation information for the target service. For example, the manipulation methods may include a manipulation of the target service performed in accordance with the number of touches onto the touch display and a manipulation of the target service performed in match with the drag (slide) direction of the touch display (e.g., an up-down direction, a horizontal direction, a diagonal direction between the upper left and lower right corners, a diagonal direction between the upper right and lower left corners, etc.)

In addition, before the target service is provided (when an application (App) associated to the target service installed in the user terminal 200 is executed at first, an initial screen on which the corresponding application (App) is executed, etc.), the service providing apparatus 100 may provide a preset guide how to use the touch display to users. In an example embodiment, the service providing apparatus 100 may provide the preset guide how to use the touch display by using a voice guidance system for a visually impaired user.

With respect to a voice input of the first accessible layer, the service providing apparatus 100 may build the first accessible layer in which the input method of filling the text type entry items is converted into a voice input, so that the visually impaired user may receive the text information (for example, filled-in contents of an item that requires typing through a keyboard on a screen for a non-disabled user, etc.), which is required being inputted in operating the target service, by the voice input.

In an example embodiment, when determining that the user enters an entry item (or entry menu) requiring that the text information be filled in, the service providing apparatus 100 may activate a voice recognition module (e.g., a microphone, etc.) of the user terminal 200 or the auxiliary terminal 300, may output a request signal requesting vocal utterance through a voice, and may treat the input of a corresponding entry item by extracting the text information corresponding to the voice recognized by the voice recognition module when the voice of the user is applied to the voice recognition module.

In addition, the service providing apparatus 100 may build the first accessible layer to include functions that enable manipulations, such as the entry (selection) to a menu, the movement between menus, etc., provided with the target service, by the control input of the voice.

In addition, in relation to the voice output of the first accessible layer, the service providing apparatus 100 may provide menu information associated with the target service, visual information displayed on the screen in a predefined situation, etc., as converted voices, based on the manipulation information and interface information associated with the target service. For example, the service providing apparatus 100 may provide a list of menus or a list of menu-related control manipulations selectable by the user in the user entry operation in a voice output method based on the menu tree information. In addition, the service providing apparatus 100 may covert text information of the target service displayed on a screen into voice information and provide the voice information to users other than the visually impaired users in a voice output method.

In an example embodiment, the service providing apparatus 100 may build the first accessible layer to include a function of guiding route information to a predefined destination in a voice output method in relation to a route guidance service to be described later. In an example embodiment, a voice guide may be output corresponding to the route information in such a manner that the route information generated by the service providing apparatus 100 may be sequentially explained in a voice based on the current location of the user.

In addition, with respect to the braille output of the first accessible layer, when at least one of the user terminal 200 and the auxiliary terminal 300 is a type of terminal usable for the braille output based on a plurality of protrusion members, the service providing apparatus 100 may convert menu information and text information associated to the target service into braille (raised letters) and may provide the braille menu and text to users. In this regard, the service providing apparatus 100 may receive information associated with whether or not the auxiliary terminal 300 is installed and whether or not the user terminal and the auxiliary terminal 300 is usable for the braille output. When determining that the adoption of the braille output is possible, the service providing apparatus 100 may be operated in such a manner that the first accessible layer for providing information in the braille output may be overlaid by at least one of the user terminal 200 and the auxiliary terminal 300.

In addition, the service providing apparatus 100 may build the second accessible layer for the hearing-impaired user in such a configuration that the second accessible layer is controlled based on at least one control input application method of a touch input method and a gesture input method, and information is displayed based on at least one information output method of an intuitive visual information output method and a gesture output method.

With respect to the gesture input method of the second accessible layer, the service providing apparatus 100 may build the second accessible layer to include functions for controlling the target service based on the gesture input in such a manner that the camera module of the user terminal 200 or the auxiliary terminal 300 is activated and the contents of the user's intention are extracted from images obtained from the camera module. Thus, the intention of the hearing-impaired user may be verified by the gesture-based communication means of the hearing-impaired user, such as sign language (sign language), spoken language (oral language), etc., through at least one of the user terminal 200 and the auxiliary terminal 300.

In addition, with respect to the intuitive visual information output method of the second accessible layer, the service providing apparatus 100 may build the second accessible layer to use the intuitive visual information, such as intuitive symbols, icons, and pictograms corresponding to the menu information and the text information associated with the target service in replace of the menu information and the text information of the target service, or to use the menu information and the text information of the target service together with the intuitive visual information in such a manner that illiterate users understand the information provided by the target service.

In this regard, the service providing apparatus 100 may include a first conversion algorithm for deriving the intuitive visual information that matches the menu information and the text information associated with the target service. For example, the first conversion algorithm may search a database 400 in which words, vocabularies, and expressions matching the reserved intuitive visual information, such as the symbols, the icons, the pictograms, etc., are combined with each other and stored together, and may select an intuitive visual information corresponding to the menu information and the text information provided by the target service from the database 400. Then, the searched intuitive visual information may be reflected in the second accessible layer by the first conversion algorithm.

In addition, in relation to the gesture output method of the second accessible layer, the service providing apparatus 100 may support the hearing-impaired user to understand the information associated with the target service by outputting sign language (sign language), oral language (spoken language), etc. matching the menu information, the text information etc. associated with the target service.

In an example embodiment, the service providing apparatus 100 may include a second conversion algorithm for converting the menu information, the text information, etc. associated with the target service into the gesture output, such as a sign language, so that predefined information is provided by the gesture output method. More Particularly, the second conversion algorithm may include a tool for generating a gesture-based avatar image corresponding to the menu information, the text information, etc. associated with the target service. The service providing apparatus 100 may build the second accessible layer that displays a gesture-based avatar image generated from text information, which corresponds to the menu information chosen by the user or corresponds to information requested by the user, by the second conversion algorithm on the user terminal 200.

In addition, according to an embodiment of the present application, the service providing apparatus 100 may build a third accessible layer for improving the visibility of various information provided by the target service in consideration of the dim-sighted users (e.g., the elderly users) having at least some residual vision. In an example embodiment, the service providing apparatus 100 may build the third accessible layer that magnifies various types of visual information, such as texts, images, and media, displayed on the execution screen of the target service, compared to the conventional ones, or improves the contrast, the sharpness, the resolution, the brightness, etc.

In addition, according to an embodiment of the present application, the service providing apparatus 100 may build the third accessible layer to include a function of selectively magnifying at least a part of a display area for displaying information associated with the target service based on a magnification request input applied from at least one of the user terminal 200 and the auxiliary terminal 300. Herein, the magnification request input may be applied in various ways, such as a touch input method by which the user selects a partial touch area of the display area for obtaining a magnified image from the partial touch area, and a gaze-based input method in which the user gazes at a partial gaze area of the display area for obtaining a magnified image from the partial gaze area.

In addition, the service providing apparatus 100 may provide the target service based on the established accessible layer. Particularly, the service providing apparatus 100 may obtain information on the disability type of a user to whom the target service is provided. In addition, the service providing apparatus 100 may provide the target service based on the accessible layer that is built corresponding to the information on the disability type obtained above.

More particularly, the service providing apparatus 100 may provide the target service by overlaying a predefined type of an accessible layer among the accessible layers previously built associated with the target service based on the disability information of a user that is received from at least one of the user terminal 200 and the auxiliary terminal 300.

In an example embodiment, when the disability type of the user corresponds to the visual impairment, the service providing apparatus 100 may provide the target service through the first accessible layer described above. When the disability type of the user corresponds to the hearing impairment, the service providing apparatus 100 may provide the target service through the second accessible layer described above.

In addition, according to an embodiment of the present application, the target service may include the route guidance service for providing route information from the departure point to the destination. In an example embodiment, the route guidance service may be a map service providing route information through a map, etc. The route information is guide information that enables the users to reach a predefined destination by walking or public transportation from the departure point input by a user or the current location of a user. In addition, the route guidance service may provide surrounding information around a particular location (e.g., a current location of a user, a specific location input by a user, etc.).

In this regard, the service providing apparatus 100 may build another accessible layer for generating at least one of route information and surrounding information based on the disability information of a user to whom the target service, i.e., the route guidance service, is provided. Then, the service providing apparatus 100 may provide the route guidance service based on the accessible layer built above.

According to an embodiment of the present application, the route information based on the disability information of a user may be a customized route information that enables the user to perform a safe and easy journey toward the destination from the predefined departure point based on the disability type information of a user reflecting the user's vision, mobility, hearing, cognitive ability, etc.

In an example embodiment, in response to the information on the disability type information of a user being a type of physical disability such as a wheelchair occupant etc., the service providing apparatus 100 may build the accessible layer to generate the route information including a passage (sidewalk) that a wheelchair can pass, and transportation etc. that a wheelchair can board. In addition, in such a case that the disability type of a user is a visual impairment, the service providing apparatus 100 may build an accessible layer for providing route information in which a passage (sidewalk) embedded with Braille (guide) blocks is determined to be preferably selected. However, the providing of route information in consideration of the disability type information may be applied in various ways other than the examples described above.

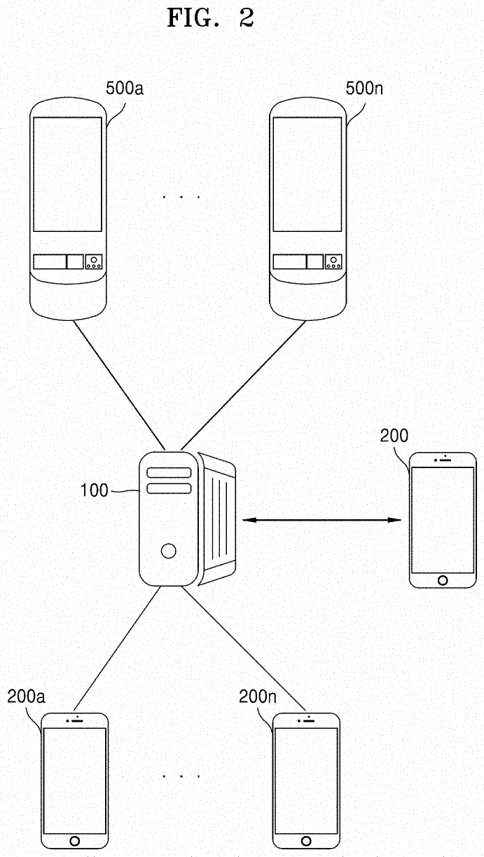

FIG. 2 is a schematic configuration view of a service providing system for providing a target service by using information obtained from a plurality of user terminals and a plurality of fixed information terminals.

Referring to FIG. 2, the service providing apparatus 100 may operate in such a way that optimized surrounding information and route information are provided by utilizing information collected (crawled) from a surrounding area for a predefined location from a plurality of user terminals (200a to 200n).

In an example embodiment, the information collected (crawled) from the plurality of user terminals (200a to 200n) may include obstacle information on fluid obstacles that are determined as an obstacle to the movement of others in a specific area by a user passing by the area.

More Particularly, when it is determined that the roadwork is abruptly carried out in a specific area and causes inconveniences to the movement of visually impaired users or wheelchair occupants, and the information (for example, a photo, video, etc. taken in the area) on the roadwork is provided to the service providing apparatus 100 by a predefined user, the service providing apparatus 100 may store the information on the roadwork in the database 400, reflect the information on the roadwork, and provide the route information neighboring the specific area to a predefined user terminal. In such a case, the service providing apparatus 100 may provide a renewal (updated) route information to avoid the identified fluid obstacles.

In addition, referring to FIG. 2, the service providing system 10 disclosed herein may include a fixed information terminal 500. In addition, a plurality of the fixed information terminals 500 may be equipped and be placed at various locations (500a to 500n), respectively. In an example embodiment, the fixed information terminal 500 may include a kiosk, digital signage, etc., and be designed in such a configuration that the user interface and the user experience may be provided in consideration of information accessibility of users corresponding to information vulnerable groups such as disabled users and elderly users.

For example, the fixed information terminal 500 may be designed and placed in such a configuration that predefined information is provided in a manner corresponding to the disability type information of a user who uses the fixed information terminal 500. In other words, the fixed information terminal 500 may perform the accessible layer-based information providing disclosed herein by interlinking with the service providing apparatus 100.

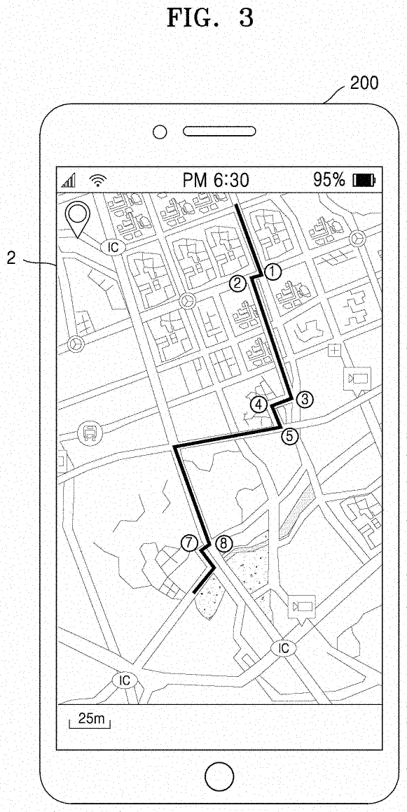

FIG. 3 is a view exemplarily illustrating a target service providing interface on a user terminal based on an accessible layer.

Referring to FIG. 3, in relation to the target service of the route guidance service, the service providing apparatus 100 may provide the route information in the form of a map in such a manner that at least one of the route information includes at least one fixed information terminal 500 that is installed in an area between a departure point and a destination. In addition, according to an embodiment of the present application, the service providing apparatus 100 may provide the route information that is determined to include a landmark previously identified with respect to an area between a departure point and a destination.

Herein, a landmark represents an area adjacent to a pertinent area and denotes a representative area which is familiarly recognized to users. For example, a landmark may be a famous store (restaurant, shopping mall, etc.) in a specific area, a public transportation station, a terminal, etc., More particularly, in relation to a disabled user, the landmark may be a frequent visit place (community center, welfare institution, etc.) to which the disabled user frequently visits according to the disability type or a famous place for the disabled person with the corresponding type of disability. In addition, the service providing apparatus 100 may retain information on the landmarks, which are selected on the basis of the number of daily/weekly visitors, the visit history of the disabled user, public transport accessibility, etc., in the database 400 in advance. Thus, when the disabled user requests the route information, the service providing apparatus 100 may generate and provide the route information in such a manner that the previously identified landmark in an area between a departure point and a destination is included in the route information.

In this regard, the number symbols (\textcircled{1}, \textcircled{2}, etc.) shown in FIG. 3 may be expressed to indicate the location of the fixed information terminal 500 installed at the landmark suited to each type of disability or in the corresponding path.

In addition, the surrounding information provided by the route guidance service in the present application may include at least one of the low-rise main information for each building in the adjacent area of a predefined location, information on convenient facilities, first obstacle information on a movement impeding factor obtained in advance, and second obstacle information on a flexibly grasped movement impeding factor for the adjacent area.

In an example embodiment, as shown in FIG. 3, the service providing apparatus 100 displays map information on an adjacent area to a predefined location in such a manner that the map information reflects at least one of low-rise main information for each building conventional in the adjacent area, convenient facility information, first obstacle information on a movement impeding factor obtained in advance, and second obstacle information on the flexibly grasped movement impeding factor for the adjacent area.

Herein, in consideration of the tendency that the disabled user, the elderly user, etc. usually recognize a building or an area mainly by the low-rise (e.g., the first floor) information when multi-floored buildings exist in the corresponding area, the service providing apparatus 100 may provide the surrounding information in such a manner that the low-rise main information of the corresponding building is reflected on the map information and the information vulnerable users can easily figure the low-rise information out. In an example embodiment, the low-rise main information for each building may be displayed as such a way as a brand mark, a logo, a simplified brand name, etc. of a store (shop) located on the first floor.

In addition, the convenient facility information may include various pieces of information on a plurality of facilities (buildings), such as outdoor public transportation boarding places, welfare facilities etc. required by disabled users, elderly users etc. In addition, the convenient facility information may include space information on a particular indoor space, such as an indoor elevator, an escalator, a toilet for the disabled, an information desk, etc., required by disabled users, elderly users etc.

In an example embodiment, the convenient facility information may be reflected in the above-described map information as intuitive visual information that is built previously correspondently to the type of the corresponding convenient facility or convenient space.

In addition, in the description of the embodiment of the present application, the first obstacle information indicates a fixed movement obstacle factor that can be grasped previously in a specific area, and the second obstacle information indicates a flexible movement obstacle factor that can be grasped in real time based on the particular situation in a specific area. In an example embodiment to help understanding, the first obstacle information may include stairs, rough roads, bumps, bollards, etc., and the second obstacle information may include vehicles, motorcycles, bicycles, electric kickboards, etc., which can be flexibly disposed on the sidewalks or near the roads, construction/accident site, etc.

Particularly, the service providing apparatus 100 may store and retain the first obstacle information about a specific area, which is investigated previously, in the database 400. In addition, the service providing apparatus 100 may retain the second obstacle information for the corresponding area in a way that is provided in real time from at least one of the plurality of user terminals (200a to 200n), or in a way that is provided in real time from at least one of the plurality of fixed information terminals (500a to 500n).

In addition, the service providing apparatus 100 receives the second obstacle information for the area in real time from at least one of the plurality of user terminals 200a to 200n or from at least one of the plurality of fixed information terminals 500a to 500n. It may be held in a way that is provided in real time.

In addition, according to an embodiment of the present application, the service providing apparatus 100 may obtain the location information of the user who is provided with the target service, and may provide warning alarms based on the distance between the obstacle information, which includes the first obstacle information and the second obstacle information, and the obtained location information of the user (e.g., current location).

More particularly, according to an embodiment of the present application, the service providing apparatus 100 may obtain the user's current location as the location information, and may provide the warning alarms to at least one of the user terminal 200 and the auxiliary terminal 300 when the location information is determined to be close to the first obstacle information or the second obstacle information, which is obtained from surroundings of the area corresponding to the user's current location, within a preset threshold range.

In an example embodiment, the warning alarms may be provided in such a form as a warning voice, a warning sound, vibration, etc. However, the warning alarms should not be limited to the forms described above, and may be provided in various forms in such a manner that the user can be immediately recognize dangerous situations followed by the approach of an obstacle.

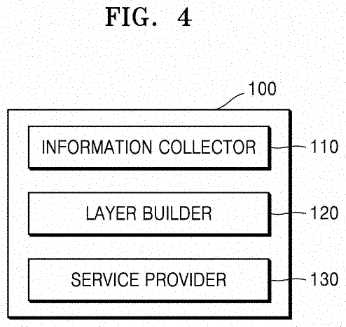

FIG. 4 is a schematic configuration view of a service providing apparatus for a layer-based service with improved information accessibility according to an embodiment of the present application.

Referring to FIG. 4, the service providing apparatus 100 may include an information collector 110, a layer builder 120, and a service provider 130.

The information collector 110 may obtain manipulation information and interface information for the target service.

The layer builder 120 may build an accessible layer corresponding to the target service by improving the information accessibility linked to the user interface d the user experience of the target service based on the manipulation information and the interface information.

Particularly, the layer builder 120 may build the first accessible layer for the visually impaired user in which the first accessible layer is controlled based on at least one control input application method of a touch input method and a voice input method and predefined information is displayed based on at least one information output method of a voice output method and a braille output method.

In addition, the layer builder 120 may build the second accessible layer for the hearing-impaired user in which the second accessible layer is controlled based on at least one control input application method of a touch input method and a gesture input method, and predefined information is displayed based on at least one information output method of an intuitive visual information output method and a gesture output method.

In addition, the target service may include a route guidance service for providing at least one of route information from a departure point to a destination and surrounding information about a predefined location. In this regard, the layer builder 120 may build an accessible layer for generating at least one of the route information and the surrounding information based on the disability type of a user who is provided with the route guidance service.

The service provider 130 may provide the target service based on the built accessible layer.

Particularly, the service provider 130 may obtain the information of the disability type of a user who is provided with the target service, and may provide the target service based on the accessible layer built in correspondence to the obtained disability type.

Hereinafter, the operation flow of the present application will be briefly given based on the details described above.

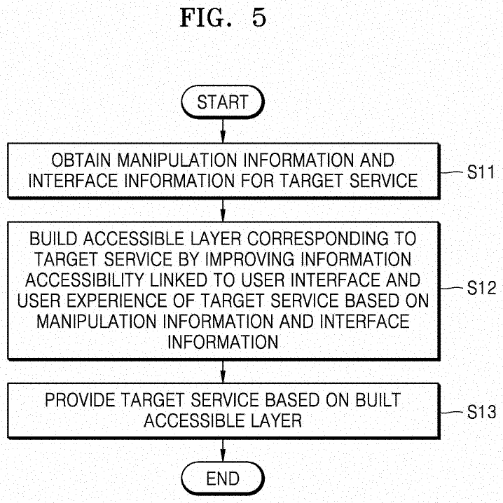

FIG. 5 is an operation flowchart showing a method of providing a layer-based service with improved information accessibility according to an embodiment of the present application.

The method of providing a layer-based service with improved information accessibility illustrated in FIG. 5 may be performed by the service providing apparatus 100 described above. Therefore, although omitted below, the descriptions of the service providing apparatus 100 may be the same as those of the method of providing a layer-based service with improved information accessibility.

Referring to FIG. 5, the information collector 110 in operation S11 may obtain the manipulation information and the interface information for the target service.

Next, in operation S12, the layer builder 120 may build the accessible layer corresponding to the target service by improving the information accessibility linked to the user interface and the user experience of the target service based on the manipulation information and the interface information that is obtained in operation S11.

Particularly, in operation S12, the layer builder 120 may build the first accessible layer for the visually impaired user in which the first accessible layer is controlled based on at least one control input application method of a touch input method and a voice input method and predefined information is displayed based on at least one information output method of a voice output method and a braille output method.

In addition, in operation S12, the layer builder 120 may build the second accessible layer for the hearing-impaired user in which the second accessible layer is controlled based on at least one control input application method of a touch input method and a gesture input method, and predefined information is displayed based on at least one information output method of an intuitive visual information output method and a gesture output method.

Next, in operation S13, the service provider 130 may provide the target service based on the accessible layer that is built in operation S12.

Particularly, in operation S13, the service provider 130 may obtain the disability type of the user who is provided with the target service. In addition, in operation S13, the service provider 130 may provide the target service based on the accessible layer that is built correspondently to the obtained disability type.

In the descriptions given above, operations S11 to S13 may be further divided into additional operations or be combined into fewer operations, according to an embodiment of the present application. In addition, some operations may be omitted if necessary, and the order between the operations may also be changed.

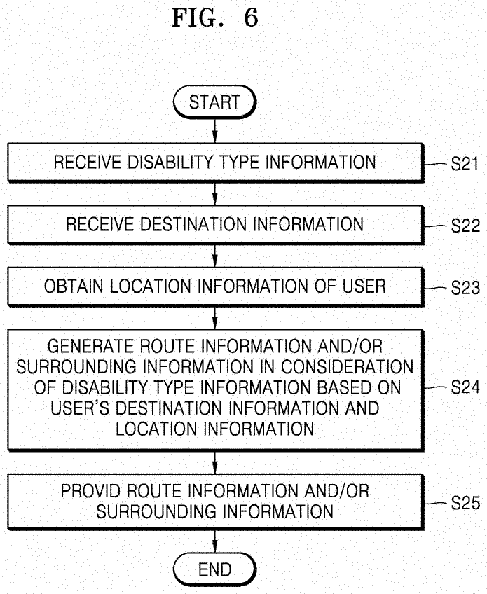

FIG. 6 is a detailed operation flowchart showing a method of providing a layer-based service with improved information accessibility in which a route guidance service is provided as the target service.

The method of providing a layer-based service with improved information accessibility in which the route guidance service is provided as the target service illustrated in FIG. 6 is performed by the service providing apparatus 100 described above. Therefore, although omitted below, the descriptions of the service providing apparatus 100 may be the same as those of the method shown in FIG. 6.

Referring to FIG. 6, in operation S21, the service providing apparatus 100 may receive the disability type information of a user from at least one of the user terminal 200 and the auxiliary terminal 300.

Next, in operation S22, the service providing apparatus 100 may receive the destination information of the user from at least one of the user terminal 200 and the auxiliary terminal 300.

Next, in operation S23, the service providing apparatus 100 may obtain the location information of the user based on at least one of the user terminal 200 and the auxiliary terminal 300.

Next, in operation S24, the service providing apparatus 100 may generate at least one of the route information and the surrounding information in consideration of the disability type information obtained in operation S21 based on the user's destination information and location information.

Next, in operation S25, the service providing apparatus 100 may provide at least one of the route information and the surrounding information, which are obtained in operation S24, by at least one of the user terminal 200 and the auxiliary terminal 300.

In the descriptions given above, operations S21 to S25 may be further divided into additional operations or be combined into fewer operations, according to an embodiment of the present application. In addition, some operations may be omitted if necessary, and the order between the operations may also be changed.

In addition, the present application may include an information terminal for supporting an access guide providing and a customized preset and a method of providing information using the same.

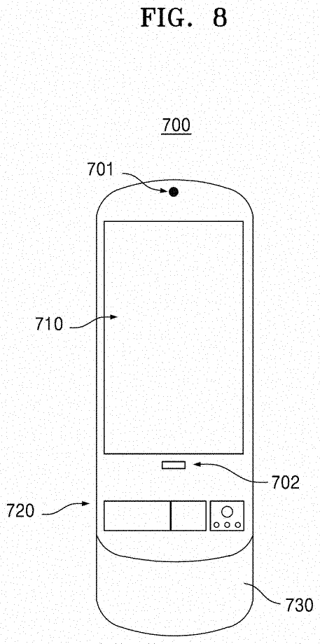

For reference, in descriptions of the embodiments of the present application, terms related to directions or positions (an up-down direction, a horizontal direction, etc.) are described based on the arrangement state of each component shown in figures. For example, when viewed in FIG. 8, the up-down direction indicates the direction from 12 o'clock to 6 o'clock, and the horizontal direction indicates the direction from 3 o'clock to 9 o'clock.

However, those settings of the direction may vary depending on the arrangement state of the apparatus of the present application. For example, the apparatus of the present application may be arranged in such a configuration that the upward direction in FIG. 8 is directed toward the horizontal direction (left and right direction), if necessary. In another example, the apparatus of the present application may be arranged in such a configuration that the upward direction in FIG. 8 is directed toward a slanted slope direction.

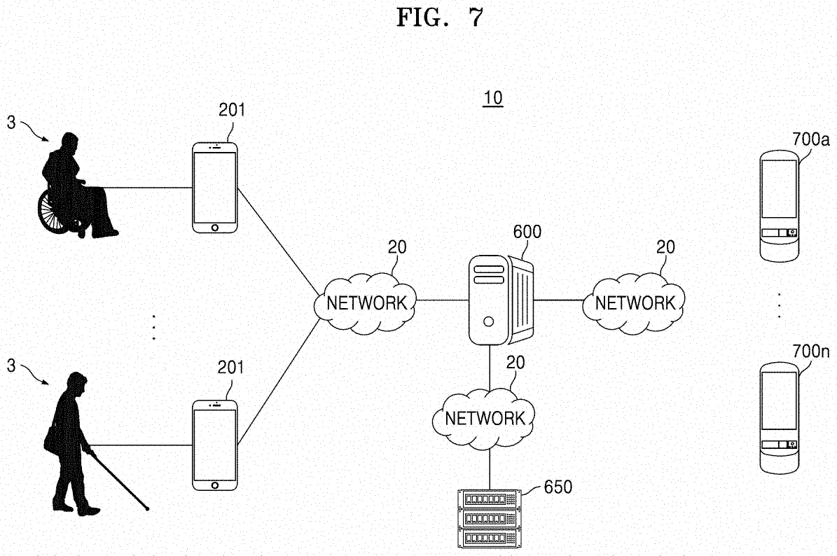

FIG. 7 is a schematic configuration view of an information providing system including an information providing apparatus that uses an information terminal for supporting an access guide providing and a customized preset according to an embodiment of the present application.

Referring to FIG. 7, the information providing system 10 according to an embodiment of the present application may include an information providing apparatus 600 using an information terminal for supporting an access guide providing and a customized preset according to an embodiment of the present application (hereinafter, refer to as ‘information providing apparatus 600’), a user terminal 201, an information terminal 700 for supporting the access guide providing and the customized preset according to an embodiment of the present application (hereinafter, refer to as ‘information terminal 700’), and a database 650.

The information providing apparatus 600, the user terminal 201, the information terminal 700, and the database 650 may communicate with each other over the network 20. The network 20 refers to a connection structure which enables information to be exchanged between each node, such as terminals and servers. Examples of the network 20 may include a 3rd Generation Partnership Project (3GPP) network, Long Term Evolution (LTE) network, 5G network, World Interoperability for Microwave Access (WIMAX) network, Internet, Local Area Network (LAN), Wireless Local Area Network (Wireless LAN), Wide Area Network (WAN), Personal Area Network (PAN), a wifi network, a Bluetooth network, a satellite broadcasting network, an analog broadcasting network, a Digital Multimedia Broadcasting (DMB) network, etc. However, the network is not limited to those examples described above.

For example, the user terminal 201 may include a smart phone, a smart pad, a tablet PC, etc., and all types of wireless communication devices, such as a Personal Communication System (PCS), Global System for Mobile communication (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), and Wireless Broadband Internet (Wibro) terminals.

In addition, although not shown in the figures, the information providing system 60 may include an auxiliary terminal (not shown) carried by the disabled user. For example, the auxiliary terminal (not shown) may include a device capable of outputting braille-based information for a visually impaired user (e.g., a blind person, etc.). In an example embodiment, the device capable of outputting the braille-based information may include a braille watch, a braille pad, etc. equipped with a display including a plurality of braille bumps. However, the auxiliary terminal (not shown) herein is not limited to the above-described braille-based device, and may include a wide range of various devices that can be used to assist users corresponding to information vulnerable users such as disabled users and the elderly. For example, the auxiliary terminal (not shown) may be a concept including all of various devices such as a hearing aid, an interpreter, a walking stick, and an electric wheelchair for assisting the user's vision, mobility, hearing, cognitive ability, etc. In addition, according to the embodiment of the present application, the user interacting with the information terminal 700 may have (possess) only the user terminal 201 without a separate auxiliary terminal (not shown) or may have (possess) both of the auxiliary terminal (not shown) and the user terminal (201).

In addition, referring to FIG. 7, a number of the information terminals 700 may be installed in various areas within the target space, respectively. In other words, the information providing system 60 may include a plurality of information terminals (700a, . . . , 700n). For reference, in relation to the embodiment of the present application, the ‘target space’ mainly means a multi-use facility or space used by a large number of people, such as subway stations, public transportation platforms, train stations, airports, shopping malls, department stores, parks, movie theaters, schools, stadiums, gyms, public institutions, etc. However, the target space is not limited to those described above.

In addition, the information terminal 700 may be installed in the target space for the purpose of providing the user with the route information for destinations, such as major facilities (toilets, elevators, escalators, etc.), stores (shops), and specific locations etc. in the target space. However, the information terminal 700 is not limited to those above, and may also be installed for the purpose of providing the user (passerby) with information on the target space or various types of information that is not limited to the target space.

In addition, in the description of the embodiment of the present application, the information terminal 700 may be a concept that broadly includes an unmanned device, a kiosk, a digital signage etc. In addition, as will be described in detail below, the information terminal 700 disclosed in the present application herein may be designed to provide the user interface and the user experience that is customized according to user information in consideration of information accessibility of the users corresponding to the information vulnerable users, such as the disabled user, the elderly user, etc.

In addition, in the description of the embodiment of the present application, the information providing apparatus 600 may be configured to mount in the information terminal 700 and be a subcomponent of the information terminal 700 for performing an operation to control (change) an element linked to the user interface and the user experience of the information terminal 700. In another example, according to the embodiment of the present application, the information providing apparatus 600 may include an additional device that is equipped separately from the information terminal 700 and performs an operation to control (change) an element linked to the user interface and the user experience of the information terminal 700.

The database 650 may build to such a configuration that the user information of each user is stored in advance. In addition, spatial information (e.g., location of major facilities, map information, etc.) on the target space may be stored in the database 650. In an example embodiment, the database 650 may receive the user information of the user who has (possesses) the corresponding user terminal 201 from the user terminal 201 in advance, and may retain the user information in such a configuration that the user information is stored for the corresponding user.

In addition, according to an embodiment of the present application, the user information stored in the database 650 may include not only personal information such as the user's name, age, gender, address, and contact information, but also disability information such as the disability type, the disability grade (level), etc., in case of the disabled user.

Hereinafter, an embodiment of the information providing apparatus 600 is described in detail. The information providing apparatus 600 may match an information terminal 700 interacted with a predefined user to guide (induce) the corresponding user to the information terminal 700, and may change the UI/UX settings of the matched information terminal 700 in advance to the customized settings thereof for the corresponding user.

At first, the information providing apparatus 600 may obtain location information of a user. According to an embodiment of the present application, the information providing apparatus 600 may receive the current location of the user terminal 201 carried by the user and obtain the corresponding location as the location information of the user. In an example embodiment, the information providing apparatus 600 may receive observation results of a GPS sensor, a geomagnetic sensor, and an inertial sensor, etc., which are mounted on the user terminal 201, from the user terminal to obtain the user's location.

In another example, the information providing apparatus 600 may identify the location information of the user in real time based on image information obtained from a closed-circuit television (CCTV) installed in the target space.

In still another example, the information providing apparatus 600 may identify the user's location in real time based on signals transmitted from a plurality of beacons (Beacon) installed in the target space in advance.

In addition, the information providing apparatus 600 may match the information terminal 700 based on the identified location information of the user. According to an embodiment of the present application, the information providing apparatus 600 may match any one of a plurality of the information terminals (700a, . . . , 700n) installed in the target space for the user.

In addition, according to an embodiment of the present application, the information providing apparatus 600 may perform the matching of the information terminal 700 in consideration of at least one of the user information, the route information to a predefined destination from the location information of the user, and the gap distances for reaching a plurality of the information terminals (700a, . . . , 700n) from the location information of the user, respectively.

For reference, in the description of the embodiment of the present application, the ‘user information’ may include first user information, which is user information obtained in advance from the user terminal 201 which the user possess or the database 650. In addition, the ‘user information’ may include second user information, which is user information derived from at least one of appearance characteristics, behavior characteristics, and object characteristics of a user that is identified in the process for a predefined user to have access to the information terminal 700.

According to an embodiment of the present application, the appearance characteristics of the user may include the user's height, appearance, physique, and the like. In addition, the behavior characteristics of the user may include the user's gait, body movement, and the like. In addition, the object characteristics of the user may include identification of a tool, the user terminal 201, an auxiliary terminal (not shown), clothes, a walking assistance aids, a wheelchair, and the like which the user possess.

More Particularly, in the case of a visually impaired user who wears ‘sunglasses’ and walks while carrying a ‘white cane’, the information providing apparatus 600 may identify the sunglasses and the white cane as the object characteristics of the corresponding user from images in which the corresponding user appears, to thereby recognized the corresponding user as a visually impaired user. Similarly, the information providing apparatus 600 may identify the user's walking characteristics of striking the guidance block on the ground with the white cane as the behavior characteristics, to thereby recognize the corresponding user as a visually impaired user. In this regard, the information providing apparatus 600 may have deep learning algorithms for detecting appearance objects by using a pre-learned artificial intelligence model (e.g., semantic segmentation), to thereby detect the appearance characteristics, the behavior characteristics, the object characteristics, and the like from the received images.

In other words, the user information, which is required for performing the matching of the information terminal 700, for generating an access guide information described in detail below, and for changing settings of elements linked with the user interface and the user experience (User Experience), which are provided from the information terminal 700, into customized settings for the user, may broadly include advance information obtained from the user terminal 201, the database 650, and the like or analysis information obtained in real time by image analysis to a terminal user who uses the information terminal 700 (more particularly, a user having access to the matched information terminal 700).

More Particularly, the information providing apparatus 600 may perform the matching of the information terminal 700 in consideration of information related to a user's walking ability, such as disability information included in the user's information of a user. Herein, performing the matching in consideration of the information related to the walking ability may be the matching of the information terminal 700 performed in consideration of the gap distance from the user's current location to predefined information terminal 700. Particularly, the information providing apparatus 600 may operate to match the information terminal 700 in such a way that an information terminal 700 to which the user easily reach in consideration of the user's walking ability is matched instead of an information terminal 700 of which the gap distance from the current location is minimal.

In an example embodiment, with respect to the walking ability, when the disability information of the user is a physical disability type such as a wheelchair occupant, a particular information terminal 700 may be excluded from the matching in such a case that there are difficulties for the user of the wheelchair occupant in having access to the corresponding information terminal 700 from current location on the path, such as a staircase, in the matching process.

In addition, according to an embodiment of the present application, when the user is moving toward a predefined destination (e.g., in case of walking or moving while being provided with route information toward the predefined destination by a navigation application, a route guidance application, etc. executed in the user terminal 201), the information providing apparatus 600 may match the information terminal 700 in consideration of the route information from the user's location information to the corresponding destination on the basis that the user is moving toward the predefined destination. For example, the information providing apparatus 600 may calculate gap distances for reaching a plurality of the information terminals (700a, . . . , 700n), respectively, from the routes in the route information (e.g., the route information provided from the navigation application, the route guidance application, etc.), and may operate in such a way that a matching probability of the information terminal 700 increases as the calculated gap distance thereof is smaller.

In addition, when predefined information terminal 700 is matched among a plurality of information terminals (700a, . . . , 700n), the information providing apparatus 600 may provide the user with the access guide information for the matched information terminal 700. Herein, the access guide information may include information for guiding a path from the user's current location to the location of the matched information terminal 700.

In an example embodiment, the access guide information may be generated from the information providing apparatus 600 and be transmitted to at least one of the user terminal 201 and the auxiliary terminal (not shown).

In addition, according to one embodiment of the present application, the information providing apparatus 600 may generate the access guide information for guiding the path from the current location of the user to the location of the matched information terminal 700 in consideration of at least one of the disability information and the walking ability in the user information of the user. In addition, the information providing apparatus 600 may transmit the matching result of the information terminal 700 and the generated access guide information to at least one of the user terminal 201 and the auxiliary terminal (not shown) that the user possess.

More Particularly, the information providing apparatus 600 may generate and provide customized access guide information for performing a journey for the user to safely and easily reach the matched information terminal 700 from the current location based on the disability information reflecting the user's vision, mobility, hearing, cognitive ability, etc.

In an example embodiment, in response to a case that the disability information of the user is a physical disability type such as a wheelchair occupant, the information providing apparatus 600 may generate and provide such an access guide information that includes a passage (sidewalk) capable of passing a wheelchair, a transportation capable of boarding a wheelchair, etc. In another example, in response to a case that the disability information of the user is a visual impairment type, the information providing apparatus 600 may generate and provide such an access guide information that preferably includes a passage (walking) path into which braille (guide) blocks are embedded. However, the providing of the access guide information may be applied in various ways other than the examples disclosed above in consideration of the disability information and the user's walking ability.

In addition, based on the user information of the user, the information providing device 600 may change the elements linked with the user interface and the user experience of the matched information terminal 700 to customized settings for the user. Here, changing the UI/UX settings of the information terminal 700 to a customized settings for the user may be understood as a process for improving the information accessibility of the information terminal 700 in consideration of the user information of the user who tries to use the matched information terminal 700.

More particularly, improving the information access to the UI/UX of the information terminal 700 may include providing a customized user interface and a customized user experience for the user by changing the information input/output process of the conventional information terminal in which the usability of the disabled user, etc. is not taken into consideration, in consideration of the information access ability of the user, such as vision, mobility, hearing, cognitive ability based on the user information including the disability type of the user. Thus, a piece of predefined information may be provided (transmitted) by the information terminal 700 in such a way that the corresponding user may conveniently manipulate and easily understand.

That is, the ‘customized settings’ in the present application may include a conversion rule for converting at least some of the elements related to the conventional user interface and the conventional user experience of the information terminal 700 in such a manner that the information terminal 700 provides the same information (contents) as previously provided for non-disabled users in a form in which the information vulnerable users can also conveniently manipulate and easily understand.

In other words, the information providing apparatus 600 may change the control input application method and the information output method which are associated with the matched information terminal 700 to a user customized type based on the user's disability information.

In summary, the information terminal 700 may be matched based on the location information of the user, and the elements associated with the user interface and the user experience of the information terminal 700 may be changed in advance into customized settings based on the user information of the corresponding user before the matched user approaches to the corresponding information terminal 700. In addition, in this regard, the information terminal 700 may include an input receiving unit (not shown) and an information output unit (not shown) for receiving a search input based on the customized settings.

FIG. 8 is a view exemplarily illustrating a shape of the information terminal according to an embodiment of the present application.

Referring to FIG. 8, the information terminal 700 may include, for example, a display 710, a main controller 720, and an auxiliary member 730. In addition, referring to FIG. 8, the information terminal 700 may include a camera module 701 for obtaining images of a user using the information terminal 700 or surrounding areas of the information terminal 700. In addition, referring to FIG. 8, the information terminal 700 may include a proximity sensor 702 for detecting the user's approach to the information terminal 700.

According to an embodiment of the present application, as shown in FIG. 8, the information terminal 700 may be designed in such a configuration that the display 710 is arranged at an upper portion, the main controller 720 is arranged at a middle portion, and an auxiliary member 730 is arranged at a lower portion. However, the configuration of the information terminal 700 is not limited to those described above. In another example, the information terminal 700 may be designed in various configurations like that the display 710 and the main controller 720 are arranged side by side in a horizontal direction and the auxiliary member 730 may be arranged under the display 710 and the main controller 720.

In addition, according to an embodiment of the present application, the display 710 may include a touch display operable to receive a touch input of a user based on a resistive type, a capacitive type, an ultrasonic (SAW) method, an infrared (IR) method, and a multi-touch method, etc.

In addition, the main controller 720 may include a physical key (e.g., four-way direction keys, number pads in a 3×4 matrix shape, hot keys, an emergency button, and select/cancel/menu function keys, etc.) for physically applying a user input, such as the search input, to the information terminal 700. In addition, the main controller 720 may include a braille display by which the visually impaired user applies a predefined control input or by which the visually impaired user recognizes the information provided by the information terminal 700 in a braille method.

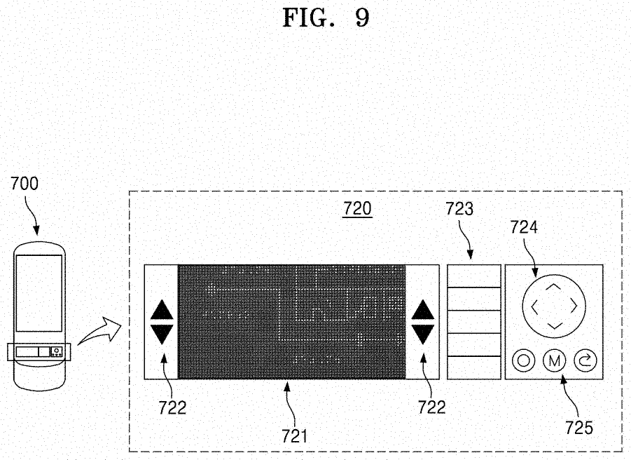

FIG. 9 is a view exemplarily illustrating a detailed structure of the main controller of the information terminal according to an embodiment of the present application.

Referring to FIG. 9, the main controller 720 of the information terminal 700 may include a braille display 721, scrolls 722 for the braille display 721, hot keys 723, direction keys 724, and function keys 725. The scrolls 722 for the braille display may be provided for updating the information displayed on the braille display 721 up and down by the user's scroll-up or scroll-down control in consideration of the limited space of the braille display 721. In addition, FIG. 9 shows that the scroll keys 722 for the braille display 721 updates the braille display 721 in two vertical directions up and down, which does not limit the configuration of the scrolls 722. The scrolls 722 may be provided in such various forms that the scrolls 722 updates the braille display 721 in four directions, horizontally, vertically, or side by side or the scrolls 722 may further include a button for enlarging or reducing the display 721.

In addition, the hot keys 723 may be provided for direct accesses to frequent information frequently requested by a large number of users among the information provided by the information terminal 700. For example, when the target space is a subway station, the hot keys 723 may correspond to a plurality of menus for guiding, location of an information (Info) desk, a location of a toilet, a location of an elevator, an exit location, etc., respectively. In addition, according to an embodiment of the present application, the information providing apparatus 600 may customize in advance the types of the information or the menu corresponding to the hot keys 723, respectively, among the information type and the menu type provided by the information terminal 700 based on the user information of the matched user.

In addition, the direction keys 724 and the function keys 725 may be provided for applying a control input related to entry (selection) and movement of the menu in relation to the hierarchical information provided in the form of a menu tree in the information terminal 700.

In addition, as described in detail with reference to FIG. 9, the braille display 721, the scrolls 722 for the braille display 721, the hot keys 723, the direction keys 724, the function keys 725, etc. of the main controller 720 may be arranged side by side in the horizontal direction as shown in FIG. 9, which does not limit the arrangements thereof. Thus, any further arrangements may be possible, for example, in such a form that the hoy keys 723, the direction keys 724, the function keys 725, etc. are arranged above or below the area in which the braille display 721 and the scrolls 722 are provided.

In addition, according to an embodiment of the present application, the main controller 720 may include a wireless communication module (not shown) provided for interconnecting the information terminal 700 and the user terminal 201 of the user or for paying a predefined fee based on a user's payment form (e.g., a credit card). In an example embodiment, the wireless communication module may include various wireless communication modules that are already known or developed in the future, such as an NFC tag, a RFID tag, a Zigbee module, a Zing module, etc.

In addition, the auxiliary member 730 may include a lifter for moving the display 710 and the main controller 720 in a position where the user interacting with the information terminal 700 can easily operate the information terminal 700 or easily verify the information provided by the information terminal 700. In an example embodiment, the lifter of the auxiliary member 730 may include a rail member for moving the display 710 and the main controller 720 upwards or downwards and a pillar member supporting the rail member, which does not limit the configuration of the lifter. In addition, the lifter of the auxiliary member 730 may be controlled based on the detection results of the camera module 701 or the proximity sensor 702.

In an example embodiment, when the user of the wheelchair occupant is checked to use the information terminal 700 as a result of the detection of the camera module 701 or the proximity sensor 702, the lifter of the auxiliary member 730 may control the display 710 and the main controller 720 to locate at a relatively low position compared to a height corresponding to the user interacting with the information terminal 700 in a standing state.

In addition, according to an embodiment of the present application, the auxiliary member 730 may include a printing module (not shown) for printing and providing the information provided from the information terminal 700 on papers after the user's usage of the information terminal 700 is terminated. Thus, the information provided from the information terminal 700 may be still utilized even after the user terminates the usage of the corresponding information terminal 700. In addition, according to an embodiment of the present application, the printing module (not shown) may include a braille printing module for converting predefined information into a braille form and outputting the predefined information as the braille form. Thus, the information may be output for the visually impaired user.

Hereinafter, a detailed embodiment of the customized settings provided by the information terminal 700 is described in consideration of the user's disability information.

When the disability information of the user is a visually impaired user, the information providing apparatus 600 may change the elements related to user interface and user experience of the matched information terminal 700 into such customized settings that the matched information terminal 700 is controlled based on at least one control input application method of a braille input, a voice input, and an intuitive touch input.

In addition, when the disability information of the user is a visually impaired user, the information providing apparatus 600 may change the elements related to user interface and user experience of the matched information terminal 700 into such customized settings that predefined information is output based on at least one information output method of a voice output method and a braille output method.

More particularly, the information providing apparatus 600 may control the information terminal 700 in such a configuration that the braille display 721, which is provided in the information terminal 700, is accessible to the user for customized settings including the control input application method of the braille input method and the information output method of the braille output method.

In this regard, according to an embodiment of the present application, the braille display 721 may be in a locked state by a predefined locker (e.g., a cover member for restricting an access to the braille display 721 in a closed state, etc.), so that the braille display 721 is prevented from being used by users other than the visually impaired user and a plurality of braille protrusions of the braille display 721 is prevented from contamination and damage. The locking state of the braille display 721 may be selectively released only when the visually impaired user intends to use the information terminal 700. Accordingly, when determining that the user corresponds to the visually impaired user based on the user information of the user matching the predefined information terminal 700, the information providing apparatus 600 may unlock the locker of the braille display 721.

For example, when the distance from the information terminal 700 to which the visually impaired user is matched is determined to locate within a preset distance range based on the location information of the user, or the user's expected arrival time to the matched information terminal 700, which is calculated based on the location information of the user, is determined to be within a preset time range, the information providing apparatus 600 may control the locker to release.

In addition, in relation to the intuitive touch input, the information providing apparatus 600 may receive the control inputs related to the entry (selection) and the movement of the menu from the touch display, which is provided with the display 710 of the information terminal 700 based on the menu tree preset with respect to the information provided from the information terminal 700, in such a manner that the control inputs of the users are received by using an entire area of the touch display, rather than being received based on buttons and icons that are locally provided on the touch display.

In an example embodiment, the information providing apparatus 600 may apply the customized settings to the matched information terminal 700 in such a configuration that the entering (selecting) and the movement of the menu provided in the information terminal 700 is manipulated by a simplified touch control method. The simplified touch control method may be a touch control input that is performed even by the visually impaired user with sufficient ease and convenience, such as a control input for touching at least a portion of an inner area of the touch display once or more, a control input for dragging (sliding) at least a portion of an inner area of the touch display, etc.

In addition, in this regard, the information providing apparatus 600 may set up various manipulation methods of the information terminal 700 in customized settings based on the menu tree preset with respect to the information provided by the information terminal 700. For example, the manipulation methods may include a manipulation of the information terminal 700 performed in accordance with the number of touches onto the touch display, a manipulation of the information terminal performed in match with the drag (slide) direction of the touch display (e.g., an up-down direction, a horizontal direction, a diagonal direction between the upper left and lower right corners, a diagonal direction between the upper right and lower left corners, etc.), etc.

In addition, the information providing apparatus 600 may guide specific details of the intuitive touch input to the user that is set before the user's interaction with the information terminal 700 is initiated (for example, in case the approach of the matched user is detected from the proximity sensor 702 of the information terminal 700, etc.). In an example embodiment, the information providing apparatus 600 may control the information terminal 700 to provide the descriptions on the intuitive touch input, which is set correspondently to the visually impaired user in the information terminal 700, through voice guidance.

In addition, in relation to the voice input, the information providing apparatus 600 apply a customized setting for converting a content input for a text-type entry item to a voice input to the information terminal 700, so that the visually impaired user may receive text information (e.g., the content to be entered for the item typing through a keyboard on a screen provided to a non-disabled user is required etc.) which is required in the manipulation process of the information terminal 700 through the voice input.

In an example embodiment, when determining that the user has entered an item (or menu) into which text information is requested to input, the information providing apparatus 600 may activate a voice recognition module (e.g., a microphone, etc.) of the information terminal 700, and may output a signal requesting utterance through voice. When the user's voice is applied, text information to the corresponding voice is extracted through the voice recognition module, and the extracted text information is input into the corresponding entry item.

In addition, the information providing apparatus 600 may apply a customized setting to the information terminal 700 in such a configuration that the customized setting includes a function to enable the manipulations such as entry (selection), movement, etc. of the menu provided by the information terminal 700 by the voice control input.

In addition, in relation to the voice output, the information providing apparatus 600 may apply a customized setting to the information terminal 700 in such a configuration that the menu information related to the information provided from the information terminal 700, visual information displayed on the screen in a predefined situation, etc. may be converted into a voice and the corresponding voice is provided. For example, the information providing apparatus 600 may provide a list of menus that the user can select or a list of menu-related control manipulations corresponding to the user entry operation, based on the menu tree, in a voice output method and provide the list to the user. In addition, the information providing apparatus 600 may apply a customized setting to the information terminal 700 in such a configuration that the text information included in the screen of the information terminal 700 that is displayed for a user other than the visually impaired user is converted into a voice and is provided to the user by the voice output.

In addition, in relation to the braille output, the information providing apparatus 600 may convert the menu information and the text information related with information provided from the information terminal 700 into braille (braille translation) and the braille is provided to the user by the braille display 721.

When the user's disability information is a hearing-impaired user, the information providing apparatus 600 may change the elements related to the user interface and the user experience of the matched information terminal 700 in a customized setting in such a configuration that the matched information terminal 700 is controlled based on at least one of the touch input and the gesture input.

In addition, when the disability information of the user is a hearing-impaired user, the information providing apparatus 600 may change the elements related to the user interface and the user experience of the matched information terminal 700 in a customized setting in such a configuration that the matched information terminal 700 provides the information based on at least one information output method of an intuitive visual information output method and a gesture output method.

More particularly, in relation to the gesture input, the information providing apparatus 600 may apply the customized setting including a control function of the information terminal 700 based on the gesture input to the information terminal 700 in such a configuration that the camera module 701 of the information terminal 700 is activated and the contents of the user's intention are extracted from the images obtained from the camera module 701, so that the intention of the hearing-impaired user are verified by the gesture-based communication means of the hearing-impaired user, such as sign language (sign language), spoken language (oral language), etc.

In addition, in relation to the intuitive visual information output method, the information providing apparatus 600 may apply the customized setting to the information terminal 700 in such a configuration that the intuitive visual information, such as intuitive symbols, icons, and pictograms corresponding to the conventional menu information and the conventional text information associated with the target service are displayed on the information terminal 700 in replace of the conventional menu information and the conventional text information or together with the conventional menu information and the conventional text information, so that even illiterate users understand the information provided by the target service.

In this regard, the information providing apparatus 600 may include a first conversion algorithm for deriving the intuitive visual information that matches the menu information and the text information associated with the target service. For example, the first conversion algorithm may search the database 650 in which words, vocabularies, and expressions matching the reserved intuitive visual information, such as the symbols, the icons, the pictograms, etc., are combined with each other and stored together, and may select an intuitive visual information corresponding to the menu information and the text information provided by the target service from the database 400. Then, the searched intuitive visual information may be reflected in the customized settings.

In addition, in relation to the gesture output, the information providing apparatus 600 may support the hearing-impaired user to understand the information provided from the information terminal 700 in such a way that a sign language (sign language), an oral language (spoken language), etc., which matches the menu information and the text information associated with the information terminal 700, are output.

In an example embodiment, the information providing apparatus 600 may include a second conversion algorithm for converting the menu information, the text information, etc. associated with the target service into the gesture output, such as a sign language, so that predefined information is provided by the gesture output. More particularly, the second conversion algorithm may include a tool for generating a gesture-based avatar image corresponding to the menu information, the text information, etc. associated with the target service. The service providing apparatus 600 may apply the customized setting to the information terminal 700 in such a configuration that the gesture-based avatar image generated from the text information, which corresponds to the menu information chosen by the user or corresponds to information requested by the user, by the second conversion algorithm is displayed on the information terminal 700.

In addition, according to an embodiment of the present application, the information providing apparatus 600 may apply the customized setting to the information terminal 700 in such a configuration that the visibility of various information provided from the information terminal 700 may be improved in consideration of dim-sighted users (e.g., the elderly users) having at least some residual vision. In an example embodiment, the information providing apparatus 600 may apply the customized setting to the information terminal 700 in such a configuration that various types of visual information displayed on the display 710, such as texts, images, and media, are magnified compared to the conventional ones, or improves the contrast, the sharpness, the resolution, the brightness, etc.

In addition, when the user's disability information is a physical disability, the information providing apparatus 600 may apply the customized setting to the matched information terminal 700 in such a configuration that the information terminal 700 is controlled based on at least one control input application method among a touch input, a physical key input, and a gesture input by using the lower interface of the display.

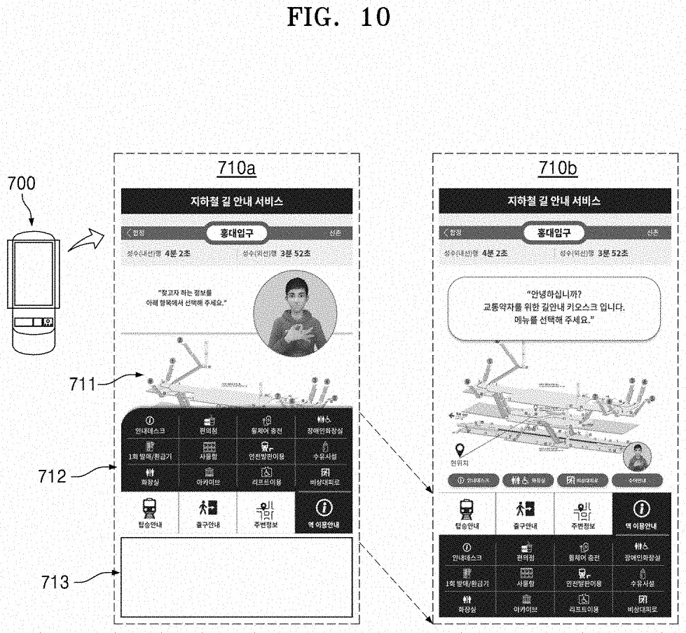

FIG. 10 is a conceptual view illustrating an input by using a lower interface as a customized setting for a physical disabled user. Particularly, (a) of FIG. 10 is an interface displayed for a normal user without a physical disability (more particularly, a user who can use the information terminal 700 in a standing state), and (b) of FIG. 10 is an interface displayed in such a way that a physically disabled user applies a touch input by using the lower interface of the display.

More particularly, the interface ((a) of FIG. 10), which is displayed on the touch display of the information terminal 700 in a normal state, may include a main area 711, a touch manipulation area 712, and an advertising area 713 that are arranged in up-down direction, so that the normal user conveniently manipulates the touch manipulation area 712 in a standing state. Meanwhile, in consideration of the physically disabled user such as a wheelchair occupant, a customized setting may be applied to the information terminal 700 to thereby change the graphic UI in such a configuration that the advertising area 713 is controlled to be eliminated or to move upwards and the touch manipulation area 712 is controlled to arranged at the lower portion of the display.

In this regard, the position of the touch manipulation area 712 for receiving the touch input on the touch display of the information terminal 700 may be appropriately determined by the customized setting for the physically disabled user such as the wheel chair occupant. In addition, as the positions of the display 710 and the main controller 720 on the information terminal 700 may be appropriately changed by the lifer of the auxiliary member 730, various usability for the physically disabled user may be given to the information controller 700 in such a way that the physically disabled user can use the touch display or the physical keys of the main controller 720. In addition, the location change control of the touch manipulation area 712 and the control of the lifter (not shown) are applied not only to the physically disabled user such as the wheelchair occupant, but also to children with small heights, so that the information terminal 700, of course, can improve the use conveniences.

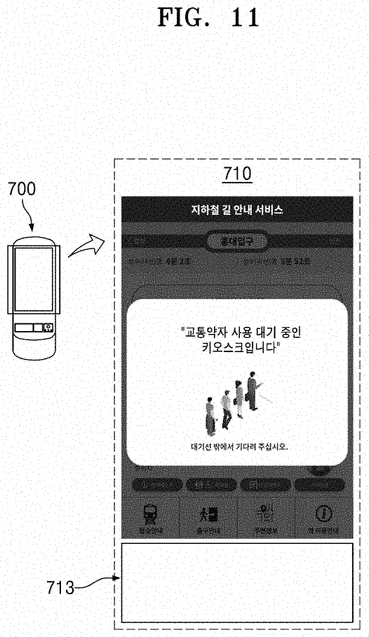

FIG. 11 is a view illustrating an interface displayed on an information terminal matching a predefined user prior to an access of the predefined user to the matched information terminal.

Referring to FIG. 11, when determining that a predefined user matching predefined information terminal 700 is close to the corresponding information terminal 700 by a predefined level or more, the information providing apparatus 600 may display a request image on the display 710 of the predefined information terminal 700 with a request phrase requesting the concession of other users in order that the predefined user matching the information terminal 700 uses the information terminal 700. Examples of the request phrase includes: “kiosk is on stand-by for the mobility handicapped. Please wait outside the waiting line.”, etc. in FIG. 11. More particularly, when the distance from the information terminal 700 to which user is matched is determined to locate within a preset distance range based on the location information of the user, or the user's expected arrival time to the matched information terminal 700, which is calculated based on the location information of the user, is determined to be within a preset time range, the information providing apparatus 600 may control the information terminal 700 to display the concession request phrase.

Then, when the matched user arrives (approaches) to the information terminal 700, the information terminal 700 may receive a search input based on the customized setting that is preset in advance prior to the arrival of the user. In addition, the information terminal 700 may provide predefined information corresponding to the search input based on the customized setting.

More particularly, according to an embodiment of the present application, when the information providing apparatus 600 may receive the search input, which is applied based on the customized setting, from the information terminal 700. Then, when the information providing apparatus 600 transmits the predefined information corresponding to the search input to the information providing apparatus 600, the information terminal 700 may display the predefined information transmitted from the information providing apparatus 600 based on the preset customized setting.

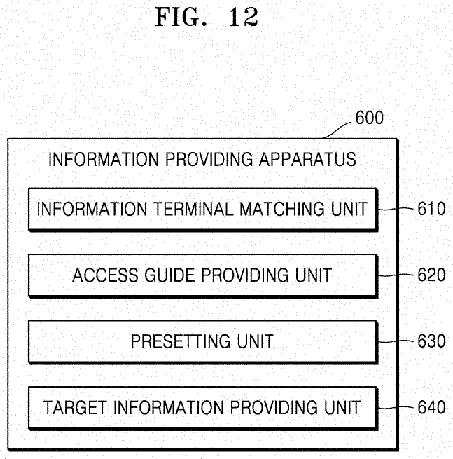

FIG. 12 is a schematic configuration view of an information providing apparatus using an information terminal which supports an access guide providing and a customized preset according to an embodiment of the present application.

Referring to FIG. 12, the information providing apparatus 600 may include an information terminal matching unit 610, an access guide providing unit 620, a presetting unit 630, and a target information providing unit 640.

The information terminal matching unit 610 may obtain the user's location information, and may match the information terminal 700 based on the obtained user's location information. Particularly, the information terminal matching unit 610 may perform the matching between the information terminal 700 and the user in consideration of at least one of the walking ability of the user, the route information to a predefined destination from the location information of the user, and the gap distances for reaching the information terminal 700 from the location information of the user, respectively.

The access guide providing unit 620 may provide the access guide information on the matched information terminal 700 to the user. Particularly, the access guide providing unit 620 may generate the access guide information for guiding a path from the user's current location (location information) to the location of the matched information terminal 700 in consideration of at least one of the user's disability information and walking ability. In addition, the access guide providing unit 620 may transmit the matching result of the information terminal 700 and the generated access guide information to at least one of the user terminal 201 and the auxiliary terminal (not shown) of the user.

The preset unit 630 may change the elements associated with the user interface and the user experience of the matched information terminal 700 into customized settings for the user based on the user information of the user.

The target information providing unit 640 may receive the search input applied to the matched information terminal 700 based on the customized setting after the user approaches the matched information terminal 700. In addition, the target information providing unit 640 transmits the predefined information corresponding to the received search input to the matched information terminal 700, and may output (provide) the predefined information on the matched information terminal 700 based on the customized setting.

Hereinafter, based on the details described above, the operation flow of the present application will be briefly described.

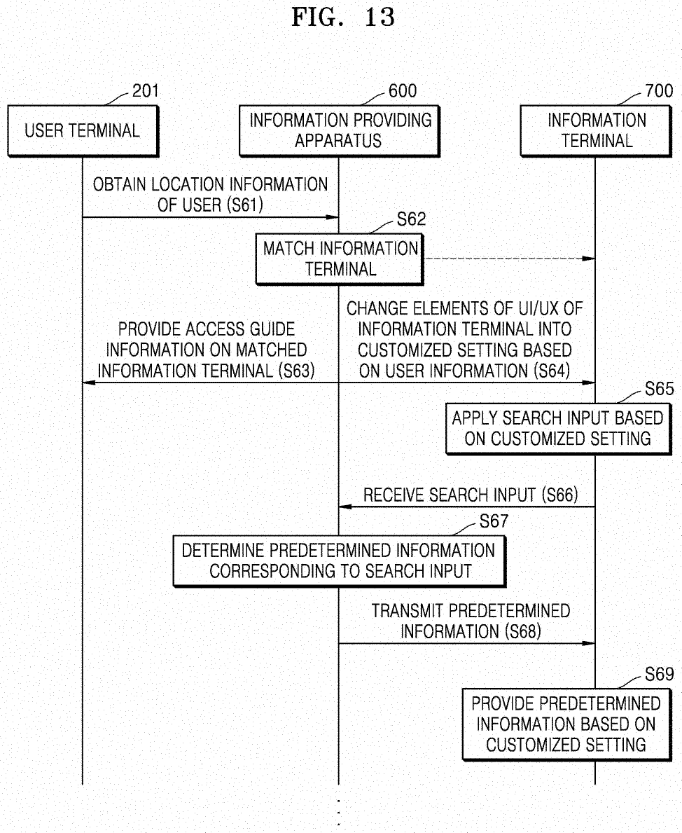

FIG. 13 is an operation flowchart of a method of providing information by using an information terminal that supports the access guide providing and the customized preset according to an embodiment of the present application.

The information providing method using the information terminal which supports the access guide providing and the customized preset shown in FIG. 13 may be performed by the information providing apparatus 600 and the information terminal 700 described above. Therefore, although omitted below, the descriptions of the information providing apparatus 600 and the information terminal 700 is the same as those of the information providing method using the information terminal which supports the access guide providing and the customized preset.

Referring to FIG. 13, in operation S61, the information terminal matching unit 610 may obtain the location information of the user.

Next, in operation S62, the information terminal matching unit 610 may match the information terminal 700 based on the obtained location information of the user. More particularly, in operation S62, the information terminal matching unit 610 may perform the matching in consideration of at least one of the user's walking ability, the route information from the location information to the predefined destination, and the gap distance from the location information to the information terminal.

Next, in operation S63, the access guide providing unit 620 may provide the access guide information on the matched information terminal 700 to the user.

More particularly, in operation S63, the access guide providing unit 620 may generate the access guide information for guiding the path from the location information to the location of the matched information terminal 700 in consideration of at least one of the user's disability information and walking ability. In addition, in operation S63, the access guide providing unit 620 may transmit the matching result and the generated access guide information to at least one of the user terminal 201 and the auxiliary terminal (not shown) of the user.

Next, in operation S64, the preset unit 630 may change the elements associated with the user interface and user experience of the matched information terminal 700 into the customized setting for the user, based on the user information of the user. More particularly, in operation S64, the presetting unit 630 may change the control input application method and the information output method associated with the matched information terminal 700 based on the user's disability information.

In addition, the user information in operation S64 may include at least one of first user information, which is user information obtained in advance from the user terminal 201 owned by the user or pre-constructed database 650 and second user information, which is user information derived from at least one of appearance characteristics, behavior characteristics, and object characteristics of a user that is identified in the process for the user to have access to the matched information terminal 700.

According to an embodiment of the present application, in operation S64, when the disability information is a visually impaired user, the presetting unit 630 may change the information terminal 700 in the customized setting in such a configuration that the matched information terminal 700 is controlled based on at least one control input application method of a braille input method, a voice input method, and an intuitive touch input method, and the predefined information is displayed based on at least one information output method of a voice output method and a braille output method.

According to an embodiment of the present application, in operation S64, when the disability information is the hearing-impaired user, the presetting unit 630 may change the information terminal 700 in the customized setting in such a configuration that the matched information terminal 700 is controlled based on at least one control input application method of a touch input method and a gesture input method, and information is displayed based on at least one information output method of an intuitive visual information output method and a gesture output method.

According to an embodiment of the present application, in operation S64, when the disability information is a physically disabled user, the presetting unit 630 may change the information terminal 700 in the customized setting in such a configuration that the matched information terminal 700 is controlled based on at least one control input application method among the touch input and the physical key input by using the lower interface of the display of the matched information terminal 700 and the gesture input.

Next, in operation S65, the matched information terminal 700 may receive the search input based on the preset customized setting after the user approaches the matched information terminal 700.

Next, in operation S66, the target information providing unit 640 may receive the search input applied by the user from the matched information terminal 700.

Next, in operation S67, the target information providing unit 640 may determine predefined information corresponding to the received search input.

Next, in operation S68, the target information providing unit 640 may transmit the determined predefined information to the matched information terminal 700.

Next, in operation S69, the matched information terminal 700 may provide the received predefined information to the user based on the preset customized setting.

In the above descriptions, operations S61 to S69 may be further divided into additional operations or be combined into fewer operations, according to an embodiment of the present application. In addition, some operations may be omitted if necessary, and the order between the operations may be changed.

### Description

In addition, the present application relates to an apparatus for providing information by interlinking of the user terminal and the information terminal and a method of providing information using the same.

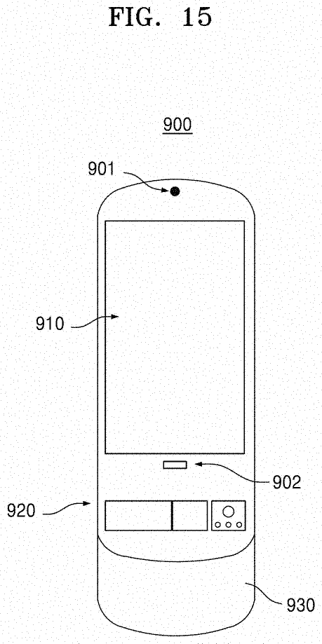

For reference, in the descriptions of the embodiments of the present application, terms related to directions or positions (up and down directions, horizontal directions, etc.) are described based on the arrangement state of each component shown in the drawings. For example, when viewed in FIG. 15, the up-down direction indicates the direction from 12 o'clock to 6 o'clock, and the horizontal direction indicates the direction from 3 o'clock to 9 o'clock.

However, those settings of the direction may vary depending on the arrangement state of the apparatus of the present application. For example, the apparatus of the present application may be arranged in such a configuration that the upward direction in FIG. 15 is directed toward the horizontal direction (left and right direction), if necessary. In another example, the apparatus of the present application may be arranged in such a configuration that the upward direction in FIG. 15 is directed toward a slanted slope direction.

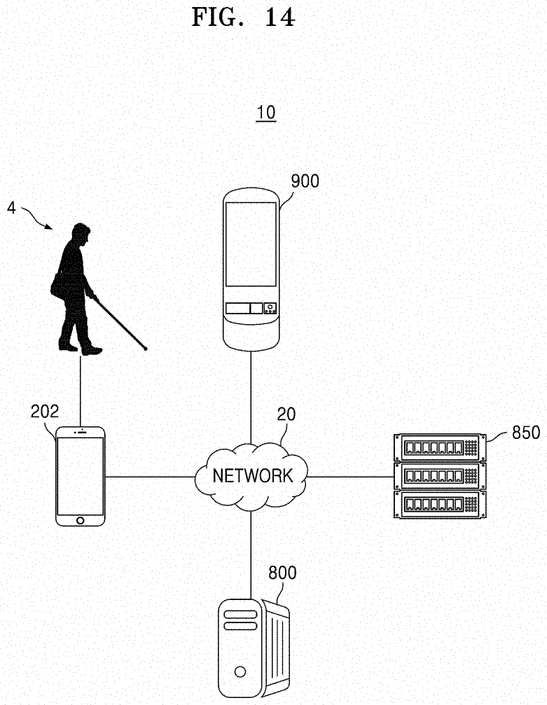

FIG. 14 is a schematic configuration view of an information providing system including an information providing apparatus in which a user terminal and an information terminal are interlinked with each other, according to an embodiment of the present application.

Referring to FIG. 14, the information providing system 10 may include an information providing apparatus 800 in which a user terminal and an information terminal are interlinked with each other (hereinafter, referred to as ‘information providing apparatus (800)’), a user terminal 202, an information terminal 900, and a database 850 according to an embodiment of the present application.

The information providing apparatus 800, the user terminal 202, the information terminal 900, and the database 850 may be communicated with each other over the network 20. The network 20 refers to a connection structure which enables information to be exchanged between each node, such as terminals and servers. Examples of the network 20 may include a 3^{rd} Generation Partnership Project (3GPP) network, Long Term Evolution (LTE) network, 5G network, World Interoperability for Microwave Access (WIMAX) network, Internet, Local Area Network (LAN), Wireless Local Area Network (Wireless LAN), Wide Area Network (WAN), Personal Area Network (PAN), a wifi network, a Bluetooth network, a satellite broadcasting network, an analog broadcasting network, a Digital Multimedia Broadcasting (DMB) network, etc. However, the network 20 is not limited to those examples described above.

In addition, referring to FIG. 14, the information providing system 80 according to an embodiment of the present application may select at least a portion of the guide data provided to the user 4 by the information terminal 900 as a target data, and may transmit the target data to the user terminal 202 matching the information terminal 900 when the user 4 uses the information terminal 900 or the interaction between the user 4 and the information terminal 900 is terminated. Thus, the user may still utilize the information provided to the user terminal 202 although the information terminal 900 is terminated and the user has left the area in which the information terminal 900 is arranged. In addition, in the description of the embodiment of the present application, the process of selecting some of the guide data provided from the information terminal 900 as the target data and transmitting the target data to the user terminal 202 is referred to as ‘Smart Mirroring’, ‘Smart Printing’, etc.

For example, the user terminal 202 may include a smart phone, a smart pad, a tablet PC, etc., and all types of wireless communication devices, such as a Personal Communication System (PCS), Global System for Mobile communication (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), and Wireless Broadband Internet (Wibro) terminals.

In addition, although not shown in the drawings, the information providing system 80 may include an auxiliary terminal (not shown) owned by a disabled user or the like. The auxiliary terminal (not shown) may be, for example, a device capable of outputting braille-based information for a visually impaired user (e.g., a blind person, etc.). In an example embodiment, the device capable of outputting braille-based information may include a braille watch, a braille pad etc. which has a display including a plurality of braille protrusion members. However, the auxiliary terminal is not limited to the device for the visually impaired user described above. Thus, the auxiliary terminal (not shown) herein may further include a wide range of various devices that can be used to assist various information vulnerable users such as disabled users and the elderly users. For example, the auxiliary terminal (not shown) may be a concept including various devices for assisting the user's vision, mobility, hearing, cognitive ability, etc., such as a hearing aid, an interpreter, a walking stick, an electric wheelchair, etc. In addition, according to the embodiment of the present application, the user interacting with the information terminal 900 may only have (own) the user terminal 202 without an additional auxiliary terminal (not shown), or may have (own) the user terminal 202 together with the auxiliary terminal (not shown).

In addition, the information terminal 900 may be installed in an area within the target space. For reference, in relation to the embodiment of the present application, the ‘target space’ mainly means a multi-use facility or space used by many people, such as subway stations, public transportation platforms, train stations, airports, shopping malls, department stores, parks, movie theaters, schools, stadiums, gyms, public institutions, etc. However, the target space is not limited to those described above.

In addition, the information terminal 900 may be installed in the target space for the purpose of providing the user with the route information for destinations, such as major facilities (toilets, elevators, escalators, etc.), stores (shops), and specific locations etc. in the target space. However, the information terminal 900 is not limited to those above, and may also be installed for the purpose of providing the user (passerby) with information on the target space or various types of information that is not limited to the target space. In addition, in the description of the embodiment of the present application, the information terminal 900 may be a concept that broadly includes an unmanned device, a kiosk, a digital signage etc.

In addition, in the description of the embodiment of the present application, the information providing apparatus 800 and 800′ may be configured to mount in the information terminal 900, and be a subcomponent of the information terminal 900 for performing an operation to control the information terminal 900 in such a way that an interlink process between the information terminal 900 and the user terminal 202 is provided and the target data is provided to the interlinked user terminal 202. In another example, according to the embodiment of the present application, the information providing apparatus 800 and 800′ may include a device or a server provided separately from the information terminal 900. Thus, the information providing apparatus 800 and 800′ may include an additional device or an additional serve for performing an operation to control the information terminal 900 in such a way that an interlink process between the information terminal 900 and the user terminal 202 is provided and the target data is provided to the interlinked user terminal 202.

The database 850 may be built in such a configuration that the user information of each user is stored in advance. In addition, spatial information on the target space (e.g., location of major facilities, map information, etc.) may be stored in the database 850. In an example embodiment, the database 850 may receive the user information of the user who has (possess) the corresponding user terminal 202 from the user terminal 202 in advance, and may hold the user information in such a configuration that the user information is stored for the corresponding user.

In addition, according to an embodiment of the present application, the user information stored in the database 850 may include not only personal information such as the user's name, age, gender, address, and contact information, but also disability information such as the disability type, the disability grade (level), etc., in case of the disabled user.

In this regard, in the descriptions of the embodiment of the present application, the user information obtained in advance from the user terminal 202 owned by the user or the database 850 is referred to as first user information. In addition, in contrast to that, the user information derived from at least one of the appearance characteristics, the behavior characteristics, and the object characteristics of a user that is identified in the process for the user to have access to the information terminal 900 or in the process for the user to interact with the information terminal 900 is referred to as second user information.

According to an embodiment of the present application, the external characteristics of the user may include the height, appearance, physique, etc. of the user. In addition, the behavioral characteristics of the user may include the gait, a body movement, etc. of the user. In addition, the object characteristics of the user may include identification of a tool, the user terminal 201, an auxiliary terminal (not shown), clothes, a walking assistance aids, a wheelchair, and the like which the user possess.

More Particularly, in the case of a visually impaired user who wears ‘sunglasses’ and walks while carrying a ‘white cane’, the information providing apparatus 800 may identify the sunglasses and the white cane as the object characteristics of the corresponding user from images in which the corresponding user appears, to thereby recognized the corresponding user as a visually impaired user. Similarly, the information providing apparatus 800 may identify the user's walking characteristics of striking the guidance block on the ground with the white cane as the behavior characteristics, to thereby recognize the corresponding user as a visually impaired user.

In this regard, the information providing apparatus 800 may have deep learning algorithms for detecting appearance objects by using a pre-learned artificial intelligence model (e.g., semantic segmentation), to thereby detect the appearance characteristics, the behavior characteristics, the object characteristics, and the like from the received images.

Hereinafter, the structure and function of the information terminal 900 disclosed herein will be described in detail at first, and then the process of transmitting the target data to the user terminal 202 by the information providing apparatus 800 will be described in detail. The information providing apparatus 800 may select some of the guide data provided from the information terminal 900 as the target data by the smart mirroring (printing) and may transmit the target data to the user terminal 202.

FIG. 15 is a view exemplarily showing the configuration of an information terminal, according to an embodiment of the present application.

Referring to FIG. 15, the information terminal 900 may include, for example, a display 910, a main controller 920, and an auxiliary member 930. In addition, referring to FIG. 15, the information terminal 900 may include a camera module 901 for obtaining an image of a user using the information terminal 900 or an image of a surrounding area of the information terminal 900. In addition, referring to FIG. 15, the information terminal 900 may include a proximity sensor 902 for detecting the user's approach to the information terminal 900.

According to an embodiment of the present disclosure, as shown in FIG. 15, the information terminal 900 may be designed in such a configuration that the display 910 is arranged at an upper portion, the main controller 920 is arranged at a middle portion, and an auxiliary member 930 is arranged at a lower portion. However, the configuration of the information terminal 900 is not limited to those described above. In another example, the information terminal 900 may be designed in various configurations like that the display 910 and the main controller 920 are arranged side by side in a horizontal direction and the auxiliary member 930 may be arranged under the display 910 and the main controller 920.

In addition, according to an embodiment of the present application, the display 910 may include a touch display operable to receive a touch input of a user based on a resistive type, a capacitive type, an ultrasonic (SAW) method, an infrared (IR) method, and a multi-touch method, etc.

In addition, the main controller 920 may include a physical key (e.g., four-way direction keys, number pads in a 3×4 matrix shape, hot keys, an emergency button, and select/cancel/menu function keys, etc.) for physically applying a user input, such as the search input, to the information terminal 900. In addition, the main controller 920 may include a braille display 920 by which the visually impaired user applies a predefined control input or by which the visually impaired user recognizes the information provided by the information terminal 900 in a braille method.

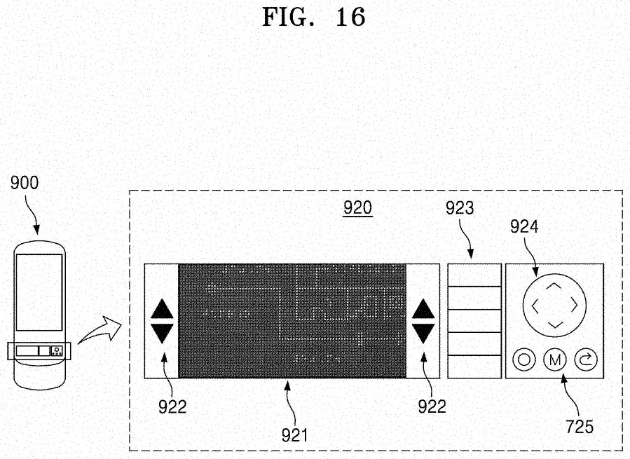

FIG. 16 is a view exemplarily illustrating a detailed structure of the main controller of the information terminal according to an embodiment of the present application.

Referring to FIG. 16, the main controller 920 of the information terminal 900 may include a braille display 921, scrolls 922 for the braille display 921, hot keys 923, direction keys 924, and function keys 925. The scrolls 922 for the braille display may be provided for updating the information displayed on the braille display 721 up and down by the user's scroll-up or scroll-down control in consideration of the limited space of the braille display 721. In addition, FIG. 16 shows that the scroll keys 922 for the braille display 921 updates the braille display 921 in two vertical directions up and down, which does not limit the configuration of the scrolls 922. The scrolls 922 may be provided in such various forms that the scrolls 922 updates the braille display 921 in four directions, horizontally, vertically, or side by side or the scrolls 922 may further include a button for enlarging or reducing the display 921.

In addition, the hot keys 923 may be provided for direct accesses to frequent information frequently requested by a large number of users among the information provided by the information terminal 900. For example, when the target space is a subway station, the hot keys 923 may correspond to a plurality of menus for guiding, location of an information (Info) desk, a location of a toilet, a location of an elevator, an exit location, etc., respectively. In addition, according to an embodiment of the present application, the information providing apparatus 800 may customize in advance the types of the information or the menu corresponding to the hot keys 923, respectively, among the information type and the menu type provided by the information terminal 900 based on the user information of the matched user.

In addition, the direction keys 924 and the function keys 925 may be provided for applying a control input related to entry (selection) and movement of the menu in relation to the hierarchical information provided in the form of a menu tree in the information terminal 900.

In addition, as described in detail with reference to FIG. 16, the braille display 921, the scrolls 922 for the braille display 921, the hot keys 923, the direction keys 924, the function keys 925, etc. of the main controller 920 may be arranged side by side in the horizontal direction as shown in FIG. 16, which does not limit the arrangements thereof. Thus, any further arrangements may be possible, for example, in such a form that the hoy keys 923, the direction keys 924, the function keys 925, etc. are arranged above or below the area in which the braille display 921 and the scrolls 922 are provided.

In addition, according to an embodiment of the present application, the main controller 920 may include a wireless communication module (not shown) provided for interconnecting the information terminal 900 and the user terminal 209 of the user or for paying a predefined fee based on a user's payment form (e.g., a credit card). In an example embodiment, the wireless communication module may include various wireless communication modules that are already known or developed in the future, such as an NFC tag, a RFID tag, a Zigbee module, a Zing module, etc.

In addition, the auxiliary member 930 may include a lifter for moving the display 910 and the main controller 920 in a position where the user interacting with the information terminal 900 can easily operate the information terminal 900 or easily verify the information provided by the information terminal 900. In an example embodiment, the lifter of the auxiliary member 930 may include a rail member for moving the display 910 and the main controller 920 upwards or downwards and a pillar member supporting the rail member, which does not limit the configuration of the lifter. In addition, the lifter of the auxiliary member 930 may be controlled based on the detection results of the camera module 901 or the proximity sensor 902.

In an example embodiment, when the user of the wheelchair occupant is checked to use the information terminal 900 as a result of the detection of the camera module 901 or the proximity sensor 902, the lifter of the auxiliary member 930 may control the display 910 and the main controller 920 to locate at a relatively low position compared to a height corresponding to the user interacting with the information terminal 900 in a standing state.

In addition, according to an embodiment of the present application, the auxiliary member 930 may include a printing module (not shown) for printing and providing the information provided from the information terminal 900 on papers after the user's usage of the information terminal 900 is terminated. Thus, the information provided from the information terminal 900 may be still utilized even after the user terminates the usage of the corresponding information terminal 900. In addition, according to an embodiment of the present application, the printing module (not shown) may include a braille printing module for converting predefined information into a braille form and outputting the predefined information as the braille form. Thus, the information may be output for the visually impaired user.

Hereinafter, the smart mirroring (printing) process disclosed herein will be described in detail.

At first, the information providing apparatus 800 may collect the guide data from an information terminal that outputs predefined information in response to an applied search input. Herein, the guide data may include information on a menu to which the user has access based on the search input among the hierarchical information that the information terminal 900 provides based on the preset menu tree and contents information which is provide to the user by the corresponding menu.

In an example embodiment, when the user applies the search input corresponding to the ‘exit location’ among the hierarchical information provided by the information terminal 900, and the ‘route information’ corresponding to a predefined exit location is provided as a content matching the corresponding menu from the information terminal 900 in response to the search input, the information providing apparatus 800 may collect the ‘exit location’ that is the menu to which the user has access and the ‘route information’ for reaching the corresponding exit location as the guide data.

In addition, the information providing apparatus 800 may link the information terminal 900 with the user terminal 202 owned by the user. According to an embodiment of the present application, the interlink process between the information terminal 900 and the user terminal 202 is not necessarily required being performed at any particular time in various time points of prior to the user interaction, of posterior to the user interaction, and during the user interaction with the information terminal 900. For example, when the user interlinks the user terminal 202 with the information terminal 900 at first by letting the user terminal 202 approach to the wireless communication module of the information terminal 900, and then, applies the search input to the information terminal 900, the interlinking process between the user terminal 202 and the information terminal 900 may be completed prior to the user's usage of the information terminal 900.

In another example, when the user terminal 202 is not interlinked with the information terminal 900 posterior to the termination of the user's usage of the information terminal 900, the information providing apparatus 800 may ask the user to perform the smart mirroring (printing) for transmitting the target data to the user terminal 202 by the interlinking with the information terminal 900. For example, the information providing apparatus 800 may guide the user to perform the smart mirroring (printing) by displaying the following guide phrases on the display of the information terminal 900: “Search has been completed. Do you want to perform the smart mirroring to the information provided by your smartphone?”

According to an embodiment of the present application, the interlinking process between the user terminal 202 and the information terminal 900, of course, may be performed in various ways, such as a bluetooth communication, a BLE communication, and a wire communication by a cable, etc., as well as the wireless communication modules, such as an NFC tag and a RFID tag, described above.

In addition, according to an embodiment of the present application, when the user terminal 202 of the user and the information terminal 900 is interlinked with each other, the information providing apparatus 800 may control the information terminal 900 in such a manner that a prior search data, which is associated with predefined information provided by the information terminal 900, is obtained from the user terminal 202, and the information, which is determined based on the search input matching the obtained prior search data and is displayed on the information terminal 900, is provided as the guide data.

In this regard, in the case of a visually impaired user, etc., as the visually impaired user has much difficulties in walking outdoors compared to a non-disabled user, and thus, has a tendency to search in advance the information on the destination (route guide, information by floor inside a building, indoor facility information, etc.) by using the user terminal 202 such as a smart phone before leaving for the journey, the information providing apparatus 800 may search for meaningful prior search data from the user terminal 202 interlinked with the information terminal 900, and may provide targeted guide data conformable to the searched prior search data, so that the information terminal 900 may immediately provide the targeted customized information to the user by using the previously searched result from the user terminal 202.

In an example embodiment, the prior search data may broadly include web page access history (URL information, etc.) obtainable by the user terminal 202, text data such as online search terms, image data, voice data, messenger, SNS data, user log, etc.

In addition, the providing of the guide data based on the search input matching the prior search data may include the example followings: when there is a search history that a particular store (shop) located in the target space to which the information terminal 900 is searched by the user terminal 202, the business information of the corresponding store (shop), the route information for reaching the corresponding store (shop), etc. are automatically provided by the information terminal 900 although if the user does not apply an additional search input to the information terminal 900.

In this regard, the information providing apparatus 800 may include a user log (search information) analyzer for matching information corresponding to the prior search data among providable information that is obtained by the information terminal 900. For example, the user log analyzer may include a keyword extraction function based on the text mining. In another example, the user log analyzer may include an artificial intelligence model (e.g., an artificial intelligence model based on a convolutional neural network (CNN)) including an image analysis or an image sorting function.

In addition, the information providing apparatus 800 may generate the target data including at least a portion of the collected guide data. More particularly, according to an embodiment of the present application, the information providing apparatus 800 may generate the target data in such sequential ways that a menu list is generated based on the menu information included in the collected guide data; the generated menu list is output on the information terminal 900; a user input for selecting a predefined menu item from the menu list is received; the guide data corresponding to the selected menu information is only chosen; and the guide data is converted into a format for transmitting to the user terminal 202.

In another example, the information providing apparatus 800 may generate the target data in such a way that the guide data corresponding to menu information entered just before the termination of the user's interaction with the information terminal 900 is selected based on the menu information of the selected guide data.

In addition, according to an embodiment of the present application, when the search input applied to the information terminal 900 of the information providing apparatus 800 includes a predefined destination, and the guide data provided corresponding to the destination includes the route information reaching the destination, the information providing apparatus 800 may generate the target data including the corresponding route information.

In addition, according to an embodiment of the present application, the information providing apparatus 800 may determine the format of the target data based on the disability information of a user. Herein, the disability information of a user may be obtained from the user information including at least one of first user information, which is obtained in advance from the user terminal 202 owned by the user or pre-constructed database 650 and second user information, which is derived from at least one of appearance characteristics, behavior characteristics, and object characteristics of the user that is identified in the process in which the user has access to the information terminal 900 or interacts with the information terminal 900.

According to an embodiment of the present application, when the disability information of the user corresponds to the visually impaired user, the information providing apparatus 800 may determine the format of the generated target data as at least one of voice data and braille data.

In relation to voice data, the information providing apparatus 800 may generate the target data by converting the contents of the guide data into voice. The guide data may include the menu information associated with information provided from the information terminal 900 and the visual information displayed on the screen in a predefined situation. For example, the information providing apparatus 800 may generate the target data in such a way that the text information, etc. displayed on the screen for a user other than the visually impaired user into a voice.

In addition, in relation to the braille data, the information providing apparatus 800 may generate the target data by converting the guide data including the menu information and text information etc. associated with information provided from the information terminal 900 into braille (braille translation).

Particularly, the information providing apparatus 800 may provide the guide dada by converting (braille translation) into braille when at least one of the user terminal 202 and the auxiliary terminal (not shown) corresponds to such a terminal type that a braille output is available. In this regard, when determining that the adoption of the braille output is possible by receiving information related to the existence of the auxiliary terminal (not shown) and related to whether or not the user terminal 202 and the auxiliary terminal (not shown) use the braille output, the information providing apparatus 800 may generate target data in a braille format. In another example, when the information terminal 900 includes a braille printing module, the information providing apparatus 800 may translate the selected target data into braille and print the braille target data on the paper, to thereby provide the target data to the user.

In addition, according to an embodiment of the present application, when the disability information of the user corresponds to the hearing-impaired user, the information providing apparatus 800 may determine the format of the generated target data as graphic data. Herein, the graphic data may include intuitive visual information, image data, moving image data, etc.

In relation to intuitive visual information, the information providing apparatus 800 may generate (process) the target data in the form of intuitive visual information such as intuitive symbols, icons, and pictograms corresponding to the menu information and the text information related to the information provided by the information terminal 900, so that an illiterate user may understand the target data. In other words, the information providing apparatus 800 may generate (process) the target data in which the menu information and the text information provided from the information terminal 900 is replaced with the intuitive visual information or is displayed together with the intuitive visual information.

In this regard, the information providing apparatus 800 may include a first conversion algorithm for deriving the intuitive visual information that matches the menu information and the text information provided from the information terminal 900. For example, the first conversion algorithm may search the database 850 in which words, vocabularies, and expressions matching the reserved intuitive visual information, such as the symbols, the icons, the pictograms, etc., are combined with each other and stored together, and may select an intuitive visual information corresponding to the menu information and the text information provided by the information terminal 900.

In addition, the graphic data may include a moving image data for guiding the content of the target data as a converted sign language. In an example embodiment, the information providing apparatus 800 may a second conversion algorithm for converting the guide data including the menu information, the text information, etc. associated with the information terminal 900 into a gesture output, such as a sign language, to thereby generate a gesture-based moving image data in such a way that the sign language (sign language), the oral language (spoken language), etc. corresponding to the menu information and the text information associated to the information terminal 900 are output, and thus, the hearing-impaired user understands the menu information and the text information.

More particularly, the second conversion algorithm may include a tool for generating the gesture-based avatar image corresponding to the menu information, the text information, etc. associated with the information terminal 900, and the service providing apparatus 800 may generate the gesture-based avatar image generated from the guide data including the text information, which corresponds to the menu information chosen by the user or corresponds to information requested by the user, by the second conversion algorithm as the target data that is transmitted to the user terminal 202.

In addition, the information providing apparatus 800 may transmit the generated target data to the linked user terminal 202. In an example embodiment, the information providing apparatus 800 may transmit target data to the user terminal 202 by a wireless communication module (not shown) of the information terminal 900.

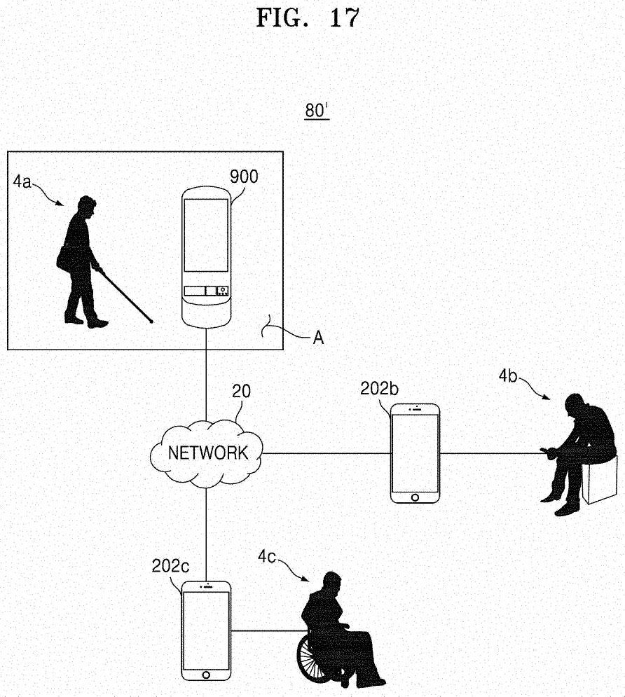

Hereinafter, an information providing apparatus in which a user terminal and an information terminal are interlinked with each other and a method of providing information using the same are described in detail with reference to FIG. 17, according to another embodiment of the present application in such a configuration that a plurality of users each has (possesses) an user terminal 202 and each user terminal 202 is individually interlinked with the information terminal 900, and thus, a plurality of the user terminals is used simultaneously.

FIG. 17 is a schematic configuration view of an information providing system including an information providing apparatus in which a user terminal and an information terminal are interlinked with each other, according to another embodiment of the present application.

Referring to FIG. 17, an information providing system 80′ including an information apparatus 800′ in which a user terminal and an information terminal are interlinked with each other (hereinafter, referred to as ‘information providing apparatus 800′’) according to another embodiment of the present application may include such a configuration that a plurality of user terminals 202b and 202c is individually connected to a single information terminal 900, and thus, a plurality of users 4a, 4b and 4c simultaneously uses the single information terminal 900.

For reference, it is preferable to be understood that the information providing apparatus 800′ and the information providing system 80′ according to another embodiment of the present application are described by using additional reference numerals separately from the aforementioned information providing device 800 and the information providing system 80 in order to specifically explain a remote usage function by a plurality of users that are different from the previously explained target data transmission function in comparison with the information providing apparatus 800 and the information providing system 80. In other words, the information providing apparatus 800 and the information providing system 80 and the information providing apparatus 800′ and the information providing system 80′ may refer to the same apparatus or system according to the embodiment of the present application.

Particularly, even when the information terminal 900 is occupied and being used by a specific user (4a of FIG. 17), the information providing apparatus 800′ may interlink individually each of the plurality of user terminals 202b and 202c with the information terminal 900 in such a configuration that a plurality of the users remotely receives the information providable from the information terminal 900 by the user terminal 202 interlinked with the information terminal 900 as long as the user approaches the information terminal 900 by a predefined level or more.

In other words, the information providing apparatus 800′ may perform an interlinking process between the information terminal 900 that outputs predefined information in response to a search input and the user terminal 202 located within a preset allowable distance from the information terminal 900 based on the wireless communication. In addition, the above-described interlinking process may be independently performed for each of the plurality of user terminals 202b and 202c.

In addition, when the user terminal 202 is interlinked, the information providing apparatus 800′ may receive the search input from the interlinked user terminal 202. In addition, the information providing apparatus 800′ may transmit the guide data, which is provided from the information terminal 900 in response to the received search input, to the user terminal 202. Herein, the guide data transmitted to the user terminal 202 may not be output on the information terminal 900. In other words, the information providing apparatus 800′ may make the information terminal 900 to provide predefined information in response to a search input by a user who directly interacts with the information terminal 900 regardless of the interlinked user terminal 202 in such a configuration that the information provided by the information terminal 900 in response to a predefined search input, which is applied to a back-end (Back-end) of the information terminal 900, is output not from the information terminal 900, but from the user terminal 202 by transmitting the information to a interlinked user terminal 202.

In an example embodiment, the information providing apparatus 800′ may control the user terminal 202 in such a way that the UI/UX elements corresponding to the elements related to the user interface and the user experience of the information terminal 900 are output from the user terminal 202 in an equal form.

Accordingly, while the conventional unmanned devices, kiosks, etc. is operated only in a limited spatial range (for example, area ‘A’ in FIG. 17), and cannot be used by other users when a first-arriving user occupies it, the information terminal 900 disclosed herein may provide the information, which is provided by the information terminal 900, to the user terminal 202 by remotely linking the user terminal 202 owned by a plurality of users in a remote location with the information terminal 900, to thereby remarkably improve the use conveniences of the information terminal 900, and since other users may have access to the information provided by the information terminal 900 even when a disabled user uses the information terminal 900 for a long time, it can be solved that the disabled user is reluctant to use the information terminal 900 due to the psychological atrophy that the disabled user may interfere with the use of other users when the disabled user uses the information terminal 900.

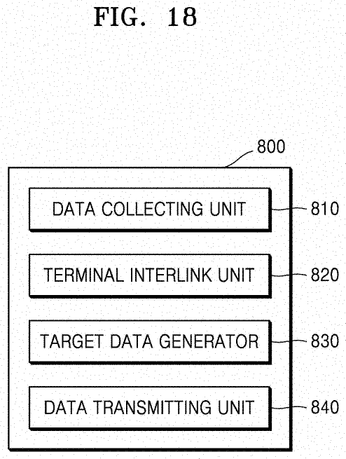

FIG. 18 is a schematic configuration view of an information providing apparatus in which a user terminal and an information terminal are interlinked with each other, according to an embodiment of the present application.

Referring to FIG. 18, the information providing apparatus 800 may include a data collecting unit 810, a terminal interlink unit 820, a target data generator 830, and a data transmitting unit 840.

The data collecting unit 810 may collect the guide data from the information terminal 900 for outputting predefined information in response to the search input. The terminal interlink unit 820 may interlink the information terminal 900 with the user terminal 202 owned by the user. The target data generator 830 may generate the target data including at least a portion of the collected guide data. The data transmitting unit 840 may transmit the generated target data to the user terminal 202.

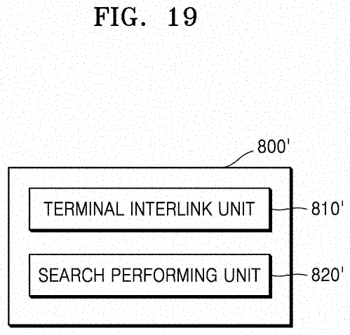

FIG. 19 is a schematic configuration view of an information providing apparatus in which a user terminal and an information terminal are interlinked with each other, according to another embodiment of the present application.

Referring to FIG. 19, the information providing apparatus 800′ may include a terminal interlink unit 810′ and a search performing unit 820′. In addition, in the descriptions of the embodiment of the present application, the terminal interlink unit 820 and the terminal interlink unit 810′ may perform functions and operations equivalent to each other.

The terminal interlink unit 810′ may link an information terminal for outputting predefined information in response to a search input with a user terminal owned by the user.

In addition, the terminal interlink unit 810′ may perform an interlink process between the information terminal 900 and a user terminal 202 positioned within a preset allowable distance from the information terminal 900 over a wireless communication of the user terminal 202 in such a way that the interlink process is performed independently on each of a plurality of the user terminals 202b and 202c.

The search performing unit 820′ may receive the search input from the linked user terminal 202, and transmit the guide data to the user terminal 202 from the information terminal 900 in response to the received search input.

Hereinafter, the operation flow of the present application will be briefly described based on the details given above.

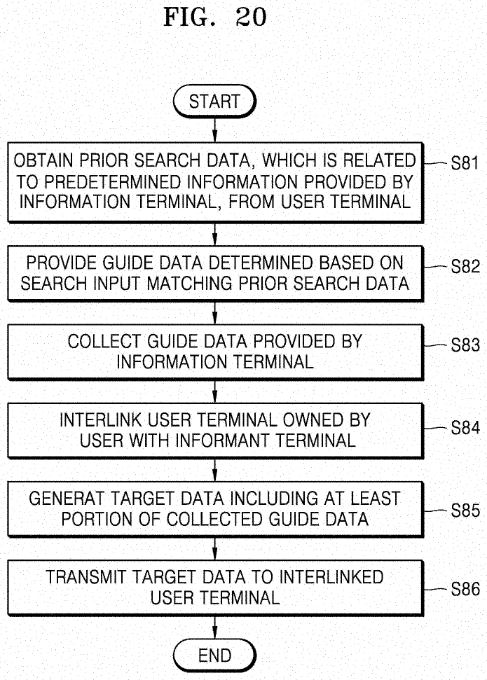

FIG. 20 is an operation flowchart showing a method of providing information by interlinking a user terminal with an information terminal, according to an embodiment of the present application.

The method of providing information by the interlink of the user terminal and the information terminal in FIG. 20 is performed by the information providing apparatus 800 described above. Therefore, although omitted below, the descriptions of the information providing apparatus 800 is the same as those of the method of providing information by the interlink of the user terminal and the information terminal.

Referring to FIG. 20, in operation S81, the information providing apparatus 800 may obtain the prior search data, which is related to predefined information that can be provided by the information terminal 900, from the user terminal 202.

Next, in operation S82, the information providing apparatus 800 may provide the guide data, which is determined based on a search input matching the obtained prior search data, to the user by the information terminal 900.

Next, in operation S83, the data collecting unit 810 may collect the guide data provided by the information terminal 900.

Next, in operation S84, the terminal interlink unit 820 may link the information terminal 900 with the user terminal 202 owned by the user.

Next, in operation S85, the target data generator 830 may generate the target data including at least a portion of the collected guide data. In addition, in operation S85, the target data generator 830 may determine the format of the target data based on the disability information of the user.

More particularly, when the disability information of the user corresponds to the visually impaired user in operation S85, the target data generator 830 may determine the format of the target data as at least one of voice data and braille data.

In addition, when the disability information of the user corresponds to the hearing-impaired user in operation S85, the target data generator 830 may determine the format of the target data as graphic data. Herein, the graphic data may include moving image data for guiding the target data after converting the target data into the sing language.

Next, in operation S86, the data transmitting unit 840 may transmit the generated target data to the linked user terminal 202.

In the descriptions given above, operations S81 to S86 may be further divided into additional operations or be combined into fewer operations, according to an embodiment of the present application. In addition, some operations may be omitted if necessary, and the order between the operations may be changed.

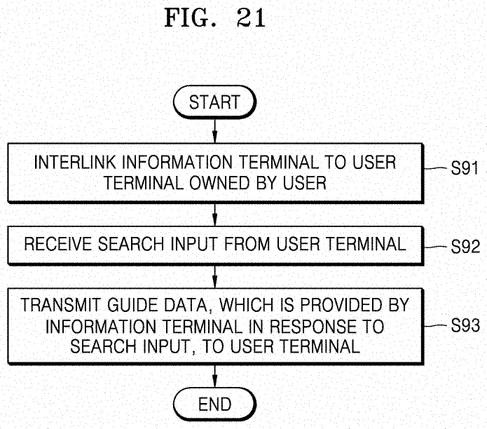

FIG. 21 is an operation flowchart showing a method of providing information by interlinking a user terminal with an information terminal, according to another embodiment of the present application.

The method of providing information by the interlink of the user terminal and the information terminal in FIG. 21 is performed by the information providing apparatus 800′ described above. Therefore, although omitted below, the descriptions of the information providing apparatus 800′ is the same as those of the method of providing information shown in FIG. 21.

Referring to FIG. 21, in operation S91, the terminal interlink unit 810′ may link the information terminal 900 that outputs predefined information in response to a search input with the user terminal 202 owned by the user. According to an embodiment of the present application, in operation S91, the terminal interlink unit 810′ may perform an interlink process between the information terminal 900 and the user terminal 202 positioned within a preset allowable distance from the information terminal 900 over a wireless communication of the user terminal 202 in such a way that the interlink process is performed independently on each of a plurality of the user terminals 202b and 202c.

Next, in operation S92, the search performing unit 820′ may receive a search input from the linked user terminal 202.

Next, in operation S93, the search performing unit 820′ may transmit the guide data provided by the information terminal 900 in response to the received search input to the user terminal 202.

In the descriptions given above, operations S91 to S93 may be further divided into additional operations or be combined into fewer operations, according to an embodiment of the present application. In addition, some operations may be omitted if necessary, and the order between the operations may be changed.

The layer-based service providing method with improved information accessibility, the information providing method by using an information terminal supporting an access guide providing and a customized preset, and the information providing method by interlinking a user terminal with an information terminal, according to an embodiment of the present application, may be recorded in a computer-readable medium in the form of program instructions that can be executed by various computers. The computer-readable medium described above may include program instructions, data files, data structures, etc. which may be used alone or in combinations thereof. The program instructions recorded in the medium above described may include program instructions that is specially designed and configured only for the present disclosure and program instructions that is known and available to those skilled in the art of computer software. The computer-readable recording medium may include hardware devices specially configured to store and execute program instructions. Examples of the hardware devices may include magnetic media such as a hard disk, a floppy disk and a magnetic tape (Magnetic Media), optical media such as a CD-ROM and a DVD (Optical Media), and magneto-optical media (Magneto-optical Media) such as a floppy disk (Floptical Disk), a ROM, a RAM, and flash memory. Examples of the program instructions may include high-level language codes executed by a computer using an interpreter, etc., as well as machine language codes such as those generated by a compiler. The hardware devices described above may be configured to operate as one or more software modules so as to perform the operations of the present disclosure, and vice versa.

In addition, the layer-based service providing method with improved information accessibility, the information providing method by using an information terminal supporting an access guide providing and a customized preset, and the information providing method by interlinking a user terminal with an information terminal described above may be implemented in the form of a computer program or application that is stored on a recording medium and executed by a computer.

The foregoing descriptions of the present application described above is illustrative of example embodiments, and those of ordinary skill in the art to which the present application pertains will understand that it can be easily modified into other specific forms without changing the technical spirit or essential features of the present application. Therefore, it should be understood that the embodiments described above are illustrative in all respects and not restrictive. For example, each component described as a single type may be implemented in a distributed manner, and likewise components described as distributed may also be implemented in a combined form.

The scope of the present application is indicated by the following claims rather than the above detailed description, and all changes or modifications derived from the meaning and scope of the claims and their equivalent concepts should be construed as being included in the scope of the present application.

1. An information providing method using an information terminal that supports an access guide providing and a customized preset, the information providing method comprising:
obtaining location information of a user terminal owned by a user;
matching the information terminal based on the location information,
providing access guide information for the matched information terminal to the user terminal, and
changing elements related to at least one of a user interface or a user experience of the matched information terminal to customized settings for the user based on the user information of the user.

2. The information providing method of claim 1, wherein
the operation of changing to customized settings comprises:
changing a control input application method and an information output method which are associated with the matched information terminal, into the customized settings based on the disability information of the user.

3. The information providing method of claim 1, wherein
the operation of matching the information terminal comprises:
matching the information terminal in consideration of at least one of walking ability of the user, route information from the location information to a predefined destination, or a gap distance from the location information to the information terminal.

4. The information providing method of claim 3, wherein
the operation of providing the access guide information comprises
generating access guide information for guiding a path from the location information to the location of the matched information terminal in consideration of at least one of the user's disability information or the walking ability, and
transmitting the matching result and the access guide information to the user terminal.

5. The information providing method of claim 2, wherein
the user information comprises
at least one of: first user information, which is user information obtained in advance from the user terminal or pre-constructed database; and second user information, which is user information derived from at least one of appearance characteristics, behavior characteristics, or object characteristics of a user which are identified in the process for the user to have access to the matched information terminal.

6. The information providing method of claim 2, wherein
the operation of changing to customized settings comprises:
when the disability information is a visually impaired user, the operation of changing to the customized setting is performed in such a way that the matched information terminal is controlled based on at least one control input application method of a braille input method, a voice input method, or an intuitive touch input method, and displaying predefined information based on at least one information output method of a voice output method or a braille output method.

7. The information providing method of claim 2, wherein
the operation of changing to customized settings comprises:
when the disability information is a hearing-impaired user, the operation of changing to the customized setting is performed in such a way that the matched information terminal is controlled based on based on at least one control input application method of a touch input method or a gesture input method, and displaying information based on at least one information output method of an intuitive visual information output method or a gesture output method.

8. The information providing method of claim 2, wherein
the operation of changing to customized settings comprises:
when the disability information is a physically disabled user, the operation of changing to the customized setting is performed in such a way that the matched information terminal is controlled based on at least one control input application method of a touch input, a physical key input, or a gesture input, using a lower interface of the display of the matched information terminal.

9. The information providing method of claim 1, further comprising:
receiving a search input applied to the matched information terminal based on the customized settings after the user approaches to the matched information terminal; and
providing predefined information corresponding to the search input by the matched information terminal based on the customized settings.

10. An information providing apparatus using an information terminal that supports an access guide providing and a customized preset, the information providing apparatus comprising:
an information terminal matching unit configured to obtain location information of a user terminal owned by a user and to match the information terminal based on the obtained location information of the user;
an access guide providing unit configured to provide access guide information on the matched information terminal to the user terminal; and
a presetting unit configured to change elements associated with a user interface and a user experience of the matched information terminal into customized settings for the user based on the user information of the user.

11. The information providing apparatus of claim 10, wherein
the presetting unit is configured to
change a control input application method and an information output method which are associated with the matched information terminal, into customized settings, based on the disability information of the user.

12. The information providing apparatus of claim 10, wherein the information terminal matching unit is configured to perform the matching in consideration of at least one of walking ability of the user, route information from the location information to a predefined destination, and a gap distance from the location information to the information terminal, and
wherein the access guide providing unit is configured to generate access guide information for guiding a path from the location information to the location of the matched information terminal in consideration of at least one of the user's disability information and the walking ability, and transmit the matching result and the access guide information to the user terminal.

13. The information providing apparatus of claim 10, further comprising
a target information providing unit configured to receive a search input applied to the matched information terminal based on the customized setting after the user approaches the matched information terminal and to provide predefined information corresponding to the search input through the matched information terminal based on the customized settings.

14. An information terminal that supports an access guide providing and a customized preset,
wherein the information terminal is matched based on location information of a user terminal, and elements associated with a user interface and a user experience of the information terminal are changed in advance into customized settings based on user information of the user before the user of the user terminal approaches to the information terminal, the information terminal comprising:
an input receiving unit configure to receive a search input based on the customized settings; and
an information output unit configured to provide predefined information corresponding to the search input based on the customized settings.

15. A computer-readable recording medium having recorded thereon a program for executing the method according to claim 1 on a computer.
